(19) United States
(12) Patent Application Publication
(10) Pub. No.: US 2017/0267386 A1
(43) Pub. Date: Sep. 21, 2017

(54) DOSING AND CLEANING SAMPLE PREPARATION APPARATUS AND METHODS THEREOF

(71) Applicant: FLSmidth A/S, Valby (DK)

(72) Inventors: Vladimir Meleg, Racice-Pístovice (CZ); Miroslav Okénka, Brno (CZ)

(21) Appl. No.: 15/309,915

(22) PCT Filed: May 13, 2015
(86) PCT No.: PCT/IB2015/053529

§ 371 Date: Nov. 9, 2016

Related U.S. Application Data
(60) Provisional application No. 61/992,491, filed on May 13, 2014.
(60) Provisional application No. 62/053,333, filed on Sep. 22, 2014.

(51) Int. Cl. B65B 37/20; B08B 5/02; B08B 5/04; B08B 9/023

(52) U.S. Cl. CPC B65B 37/20; B08B 9/023; B08B 5/02; B08B 5/04; B65B 2210/08

(57) ABSTRACT

Disclosed, is a dosing apparatus [1] which is configured to provide a predetermined amount of material from one vessel to another vessel. The dosing apparatus [1] may comprise a dosing head having a dosing tube [9] and a dosing rod [12] which is movable within said dosing tube [9]. The dosing rod [12] may comprise a dosing chamber [10] which may be filled with a predetermined amount of material. Also described, is a method of dosing which utilizes the dosing apparatus [1] disclosed. In some embodiments, the method may comprise providing a dosing apparatus [1], extending the dosing rod [12] with respect to the dosing tube [9], loading the dosing chamber [10] with a predetermined amount of material, and, retracting the dosing rod [12] with respect to the dosing tube [9] to close the dosing chamber [10]. One or more air and/or liquid cleaning steps may be employed, wherein a cleaning unit [17, 117] may be utilized to clean the dosing rod [12] and/or a funnel [4].

### CROSS-REFERENCE TO RELATED APPLICATIONS

This application claims the benefit of the following priority documents: U.S. Provisional Patent Application Ser. No. 61/992,491 filed on 13 May 2014, and titled “DOSING AND CLEANING SAMPLE PREPARATION APPARATUS AND METHODS THEREOF”, and U.S. Provisional Patent Application Ser. No. 62/053,333 filed on 22 Sep. 2014, and titled “CLEANING SAMPLE PREPARATION APPARATUS AND METHODS THEREOF”. These documents are hereby incorporated by reference in their entirety for any and/or all purposes set forth herein.

### BACKGROUND OF THE INVENTION

This invention relates to sample preparation equipment and methods, and more particularly to powder sample preparation systems configured for dosing in the cement and minerals processing industries, as well as in other industries such as the chemical, food, and pharmaceutical, fine chemistry, and pyrotechnic industries, without limitation.

To date, several solutions have been employed which try to more accurately dose powder samples. For example, 3Sigma (3Σ), a division of CMT Inc., sells the GeoMate™ vibratory feeder and the Brickmaster™ coating feeders for dry material feeding applications. Such feeders are designed for gain-in-weight or loss-in-weight feeding, and are mass flow batching systems which exclusively utilize 3Sigma's GeoTray™ feed tray and MassMate™ mass flow hopper. 3Sigma claims that their feeders operate with mass flow feeding, high frequency dribble feed, instant off, and no moving parts. 3Sigma further claims that these feeders may be used for dry bulk products and may serve as a replacement to screw feeders. Loss-in-weight vibratory feeders and gain-in-weight vibratory feeders are offered by 3Sigma for gravimetric or volumetric feeding. 3Sigma claims these devices may be used for abrasive or fragile products and cohesive products, and requires low feed rates, with pulse-less feed being required. Accuracy claimed by 3Sigma is − to +0.015 grams (www.3sigma.biz).

MCPI Inc., a French company, sells fine dosing feeders/micro feeders, and powder scatterers. For instance, MCPI sells gravimetric micro feeders, loss-in-weight feeders, weighing controllers, weighed rotating bowl devices, MPCI's fine dosing principle, volumetric micro feeders, powder scatters, multi-head feeders, powder transfers, and pilot stations. MCPI's equipment is for feeding of dry materials (www.mcpi-inc.com).

Lambda Laboratory Instruments sells the LAMBDA DOSER powder feeder, which utilizes a stepping motor for powder dosing. It is a programmable powder pump for free-flowing solid substances. Lambda Laboratory Instruments claims that the LAMBDA DOSER allows automatic or continuous addition of powders and powdery and crystalline substances without a spoon. It is a laboratory instrument consisting of a dosing unit coupled to a digitally controlled stepping motor, which allows dosing of solids (www.lambda-instruments.com).

3P Innovation also provides powder filling solutions, such as aseptic and GMP powder filling to the pharmaceutical industry and custom production powder filling systems. 3P Innovation's Fill2Weight powder dispensing system uses a flexible powder dispensing nozzle (www.3Pinnovations.com).

It is desired to provide a robust system and apparatus which is configured to allow an operator to load various powdered samples of suitable amounts into a dosing chamber of a doser, provide highly accurate and highly repeatable dosing of said various powder samples, and sufficiently clean doser surfaces to avoid cross-contamination between said various powdered samples (which may be chemically different powdered samples). Embodiments of the invention may be intended for accurate dosing of powders, mechanically.

### OBJECTS OF THE INVENTION

It is, therefore, an object of some embodiments of the invention to fill and dose a chamber, regardless of powder type (e.g., sample loading).

It is also an object of some embodiments of the invention to provide highly accurate and high repeatable fine sample-powder dosing into defined containers (e.g., sample dosing).

It is further an object of some embodiments of the invention to reduce or substantially eliminate levels of cross-contamination between chemically different powder samples.

Moreover, it is an object of some embodiments of the invention to improve the way in which a pre-defined amount of powdered material may be moved from an input point to an output point (e.g., via vibrating, knocking, or use of a stepping motor).

Yet other objects of some embodiments of the invention include providing an improved way to clean doser surfaces after performing one or more dosing steps (e.g., in order to avoid cross-contaminations between materials).

These and other objects of the invention will be apparent from the drawings and description herein. Although every object of the invention is believed to be attained by at least one embodiment of the invention, there is not necessarily any one embodiment of the invention that achieves all of the objects of the invention.

### SUMMARY OF THE INVENTION

A dosing apparatus configured to provide a predetermined amount of material from one vessel to another vessel is disclosed. In some embodiments, the dosing apparatus may comprise a dosing head having a dosing tube, and a dosing rod which is movable within said dosing tube. The dosing rod comprises a dosing chamber configured for receiving material, such as a powder. In some embodiments, the dosing apparatus may comprise a first wiping seal between the dosing rod and an inner surface of the dosing tube. In some embodiments, the dosing apparatus may comprise an annular groove in the dosing rod which receives said first wiping seal. In some embodiments, the dosing apparatus may comprise a second wiping seal between the dosing rod and an inner surface of the dosing tube. A linear stepping motor may further be provided to the dosing apparatus to move the dosing rod with respect to the dosing tube.

In some embodiments, the dosing apparatus may comprise a motor operatively communicating with toothed discs. Spring means may be provided between the toothed discs, and a fastener may operatively connect at least one of said toothed discs to the dosing rod. In some embodiments, the dosing apparatus may comprise one or more stacked spring washers. In some embodiments, the dosing chamber may comprise a transverse aperture extending partially or entirely through a section of said dosing rod. In some embodiments, the dosing chamber may comprise a surface having a bottom inclined slope. The bottom inclined slope may be narrow or tapered from one end to another end. In some embodiments, the dosing chamber may comprise a surface having two lower inclined side portions. The two lower inclined portions may collectively form a “V” shape. In some embodiments, the dosing chamber may comprise a surface having two juxtaposed side portions. In some embodiments, the dosing chamber may comprise a surface having an upper portion. Any one or more of the bottom inclined slope, lower inclined side portions, juxtaposed side portions, and upper portion may be planar or non-planar (e.g., curved) surfaces, without limitation. A cleaning unit comprising one or more jets, capable of producing streams of gas (e.g., air and/or nitrogen) and/or liquid (e.g., one or more solvents, such as isopropyl alcohol), may be employed to clean a dosing head and/or a funnel, without limitation. In some embodiments, a mixing chamber may be provided to mix the gas and liquid used by the cleaning unit.

A method of dosing is also disclosed. In some embodiments, the method comprises providing a dosing apparatus which is configured to provide a predetermined amount of material from one vessel to another vessel, extending a dosing rod with respect to a dosing tube to expose a dosing chamber from the dosing tube and to increase an adjustable gap between the dosing tube and dosing rod; loading the dosing chamber with a predetermined amount of material from said one vessel; and; retracting the dosing rod with respect to the dosing tube to close the dosing chamber via the dosing tube and to decrease an adjustable gap between the dosing tube and dosing rod. The dosing rod may be movable within said dosing tube, and the dosing rod may comprise the dosing chamber.

In some embodiments, the method may further comprise the step of re-extending the dosing rod with respect to the dosing tube to expose the dosing chamber from the dosing tube and to increase an adjustable gap between the dosing tube and dosing rod, in order to move/transfer some of the predetermined amount of material from the dosing chamber to said another vessel. In some embodiments, the method further comprises the step of cleaning the dosing head by placing it into a cleaning unit equipped with one or more jets equipped to expel a gas, which may be air or nitrogen, and/or a liquid, which may comprise one or more solvents, such as isopropyl alcohol, without limitation. In some embodiments, a mixing chamber may be provided to mix the gas and liquid. In some embodiments, the cleaning unit may further comprise an exhaust connector, such as a tube or pipe which may be attached to a vacuum source, or a pressure source which is less than ambient pressure of the environment adjacent the cleaning unit. In some embodiments, the step of re-extending the dosing rod may comprise a motor moving relative surfaces of toothed discs biased by spring means, to impart a vibration to the dosing head. In some embodiments, the one or more jets may be configured to clean a dosing funnel and/or a dosing head.

It will be appreciated from this disclosure, and the drawings, that various features/components and method steps described herein may be altered without significantly departing from the scope of the invention.

### BRIEF DESCRIPTION OF THE DRAWINGS

To complement the description which is being made, and for the purpose of aiding to better understand the features of the invention, a set of drawings illustrating preferred sample preparation apparatus and methods of using the same is attached to the present specification as an integral part thereof, in which the following has been depicted with an illustrative and non-limiting character. It should be understood that like reference numbers used in the drawings may identify like components.

FIGS. 1-3 are various isometric views of a doser according to some embodiments;

FIG. 4 is a bottom plan view of the doser shown in FIGS. 1-3;

FIG. 5 is a close-up view of the doser shown in FIGS. 1-3, wherein a doser head is proximate a dosing funnel;

FIGS. 6-11, 18, and 19 suggest various cross-sectional views of the doser shown in FIGS. 1-5;

FIG. 12 shows an isometric view of a lower portion of a doser (i.e., doser head) according to some embodiments;

FIG. 13 shows a cross-section of the doser head shown in FIG. 12;

FIG. 14 is a partial cutaway of FIG. 13, more clearly showing a second wiping seal and a dosing tube which receives a dosing rod;

FIGS. 15A-B, and 17A-F show a distal dosing rod according to some embodiments;

FIG. 16 shows a lower portion of a doser according to some embodiments in cross-section, adjacent to a dosing funnel 4;

FIGS. 20 and 21 show bottom, and side cross-sectional views of a cleaning unit, respectively; according to some embodiments;

FIGS. 22-24 show two cross-sectional and one top view of a doser, respectively, according to some embodiments;

FIGS. 25-27 show a cross-sectional, side, and top view of a doser, respectively, according to some embodiments;

FIGS. 28-30 show a cross-sectional, side, and top view of a doser having a dosing head within a cleaning unit, respectively, according to some embodiments;

FIGS. 31-35 show various photographs showing a dosing head adjacent to a cleaning unit, according to some embodiments;

FIG. 36 schematically shows a doser apparatus as it performs three steps in sequence from right to left;

FIG. 37 shows a close-up photograph of a dosing rod showing a distal lip, wherein the dosing chamber in an open position after cleaning;

FIG. 38 shows a closed position dosing head, with a dosing rod positioned against a dosing tube, wherein the dosing chamber is in a closed position with a sample contained therein;

FIG. 39 shows a photograph illustrating effects of contamination to an inner doser space (dark visible red sinter spots on white CaCO₃, without the use of a first wiping seal on a dosing rod);

FIG. 40 shows a photograph illustrating a sample dosed without traces of contamination, and the positive effect of an added first wiping seal;

FIGS. 41-43 show photographs of a cleaning unit according to some embodiments; In the following, the invention will be described in more detail with reference to drawings in conjunction with exemplary embodiments.

FIGS. 44-47 show various portions of a gas+liquid cleaning unit according to some embodiments;

FIG. 48 shows a non-limiting exemplary embodiment of a liquid holding vessel;

FIG. 49 shows a non-limiting exemplary embodiment of a pump box;

FIG. 50 shows a non-limiting exemplary embodiment of a possible location of a pump box in relation to a doser apparatus;

FIG. 51 shows a non-limiting exemplary embodiment of a mixing chamber with optional one-way valve;

FIGS. 52 and 54 suggest non-limiting exemplary embodiments of possible relative locations of a dosing rod 120 with respect to a cleaning unit [117];

FIG. 53 shows a non-limiting exemplary embodiment of a possible relative location of a cleaning unit [117] and a mixing chamber [170];

FIG. 55 shows a non-limiting isometric view of a doser according to some exemplary embodiments;

FIG. 56 suggests a testing method which may be utilized to determine efficacy of the doser shown in FIG. 55 and others;

FIG. 57 suggests an electrical schematic of a power supply for a gas/liquid cleaning unit according to some embodiments;

FIG. 58 is an isometric view of a cleaning unit according to some embodiments; and,

FIGS. 59 and 60 show cutaway isometric views of the cleaning unit according to FIG. 58.

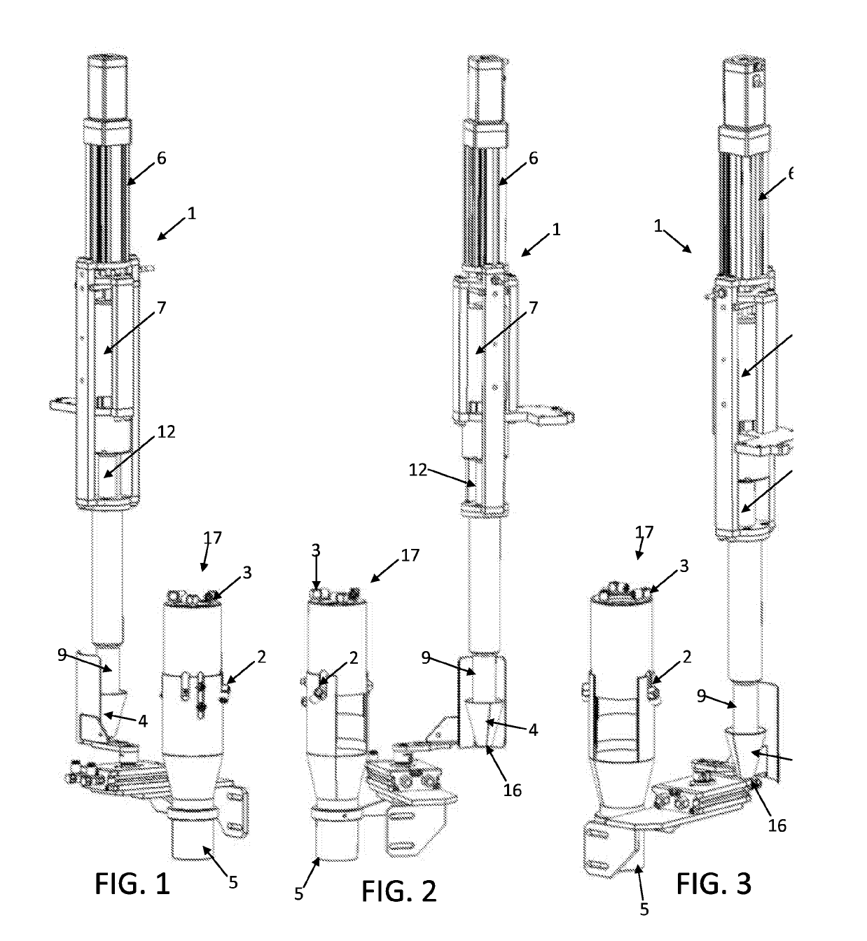

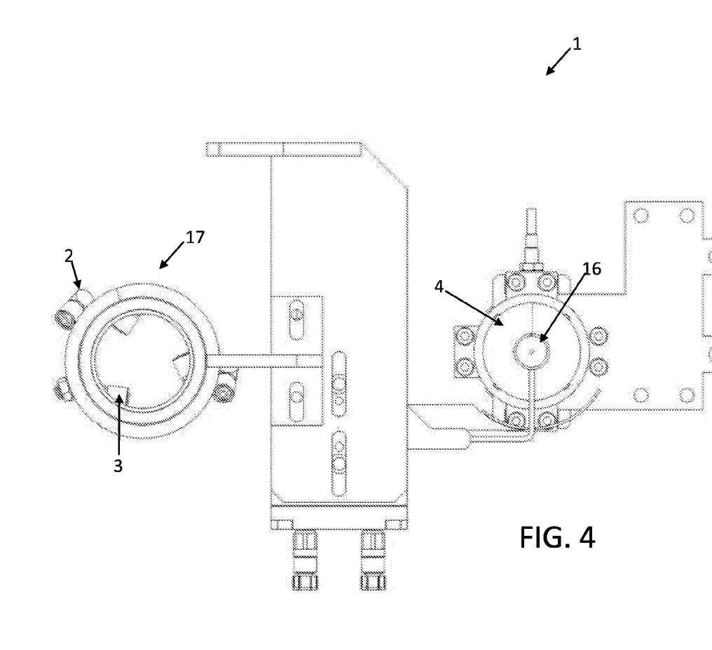

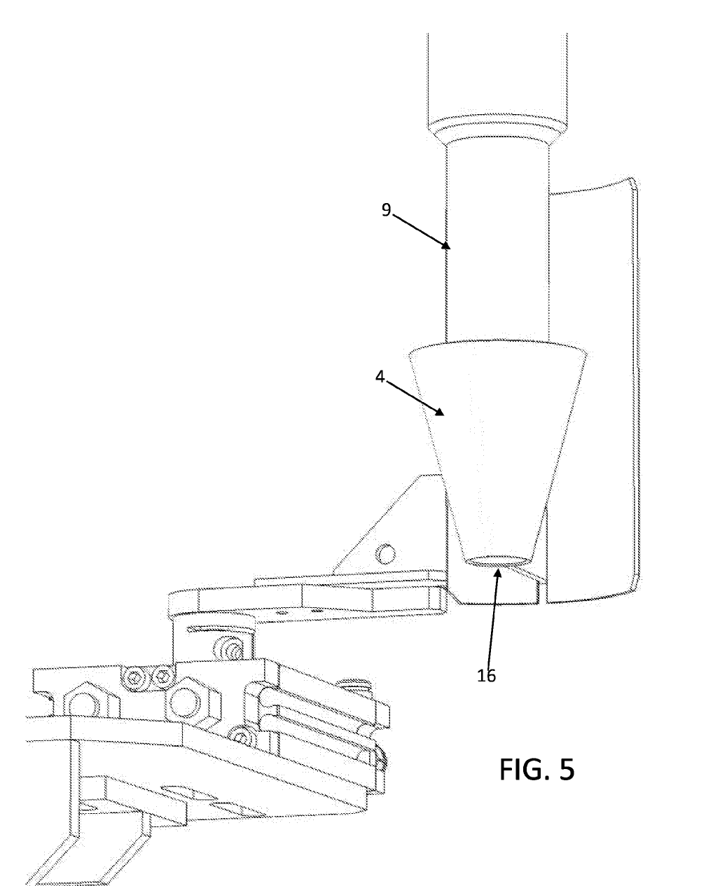

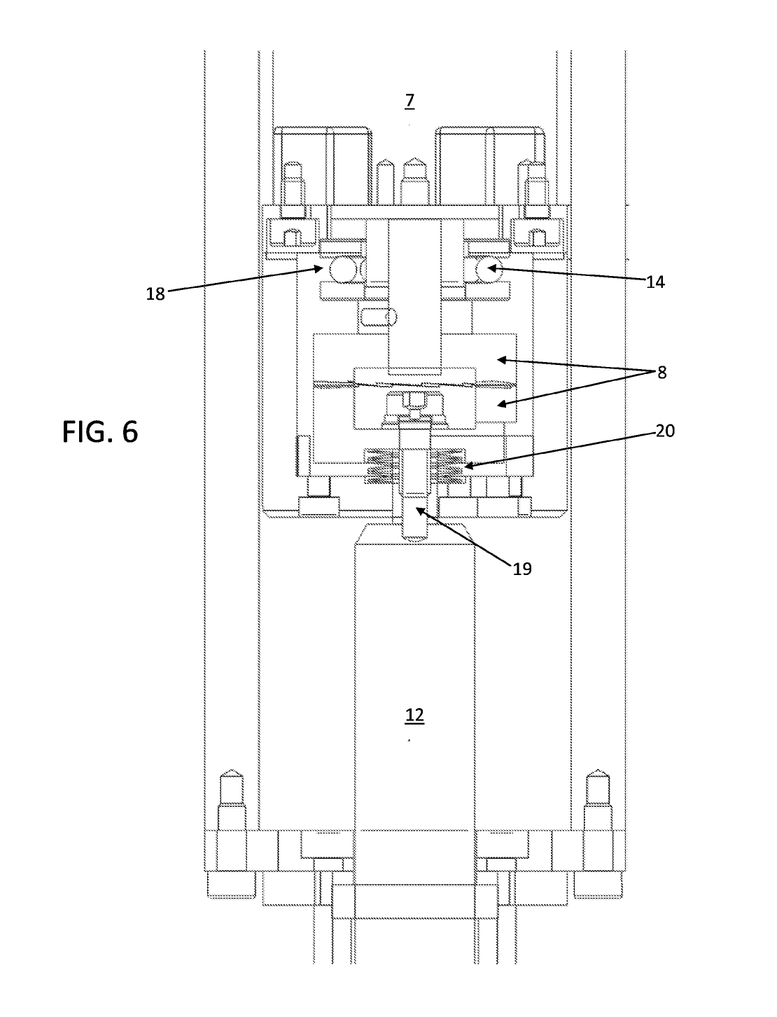

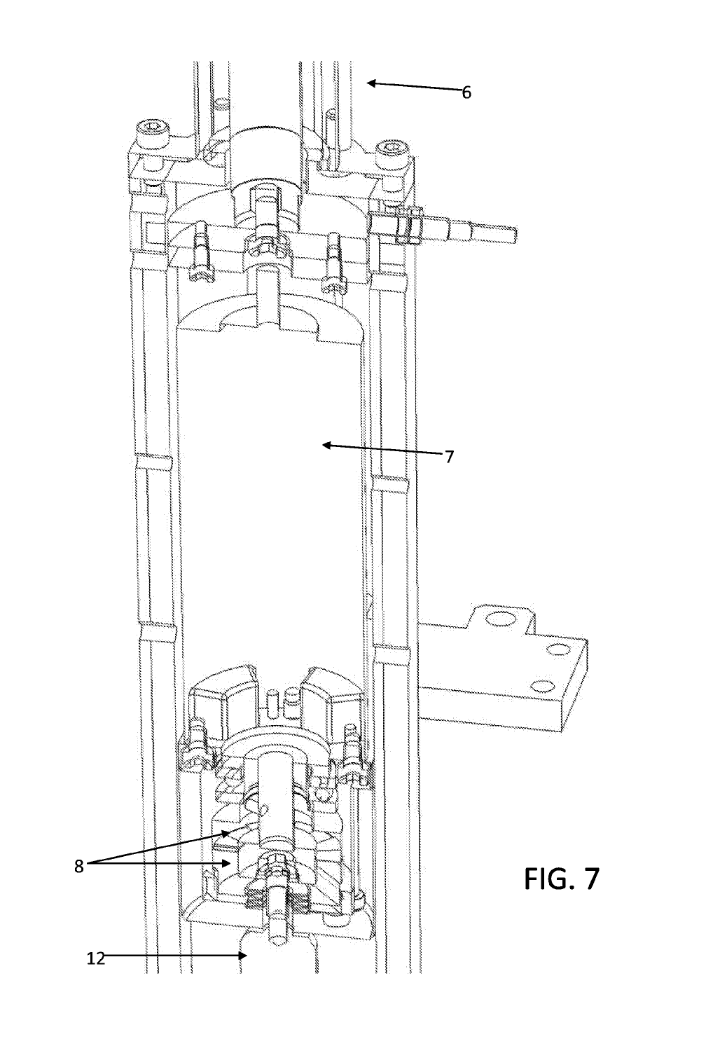

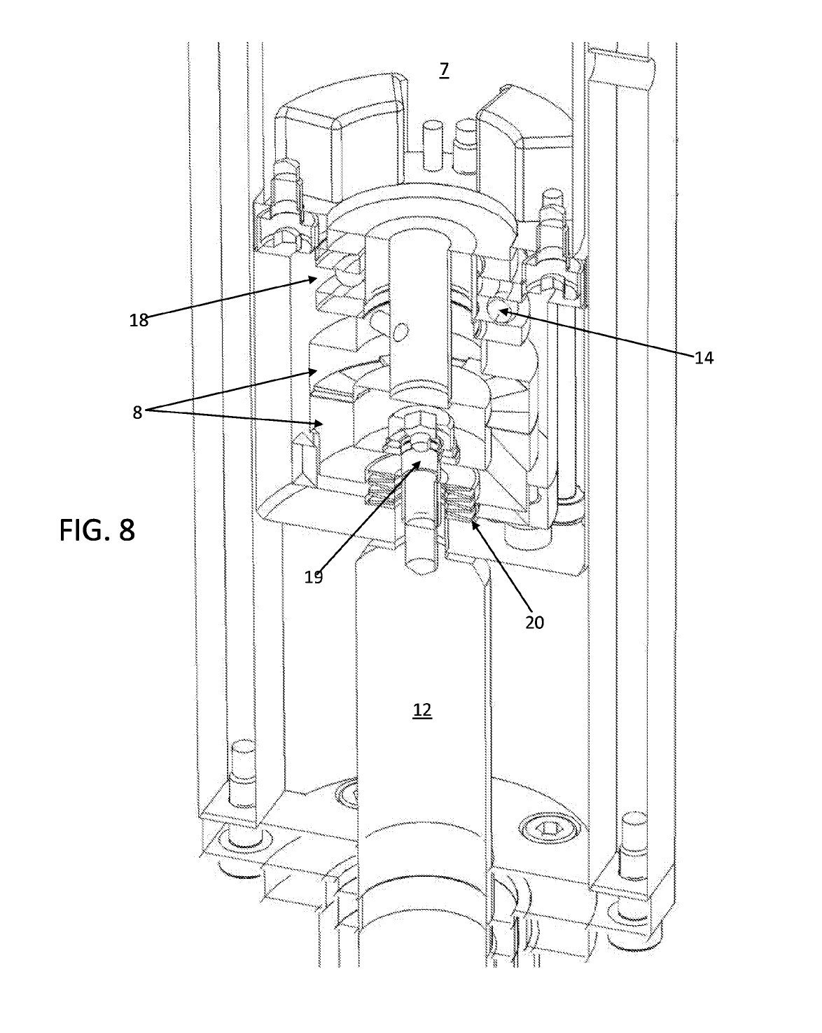

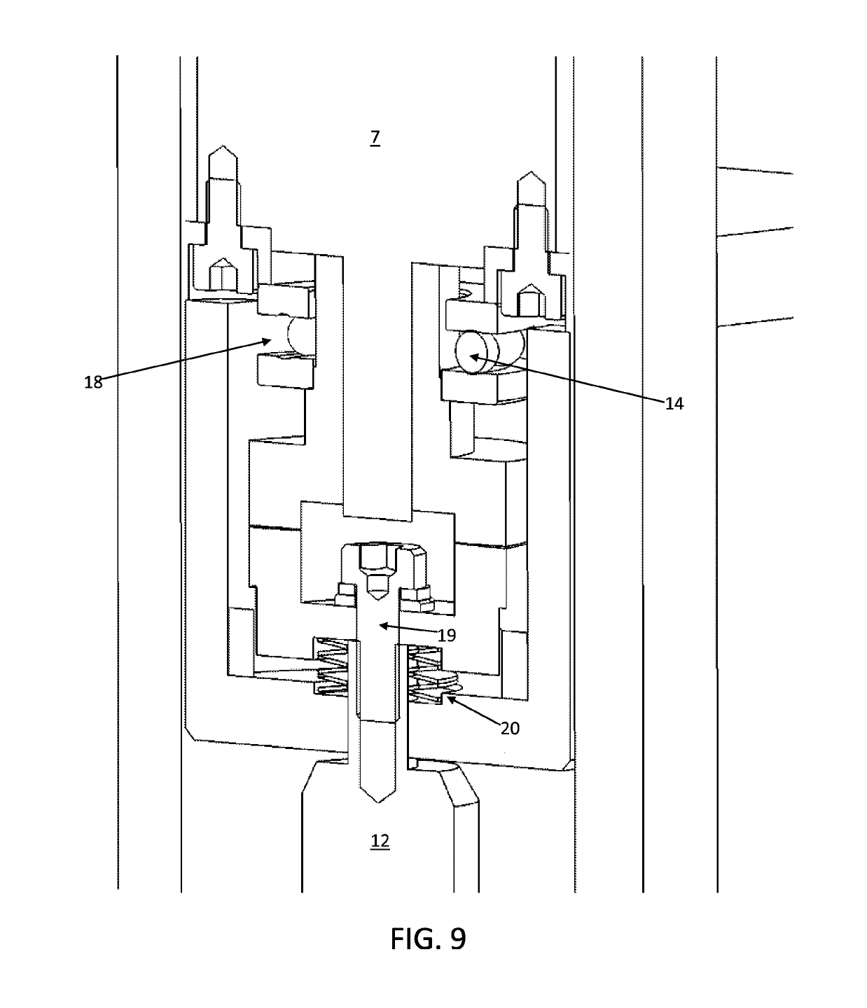

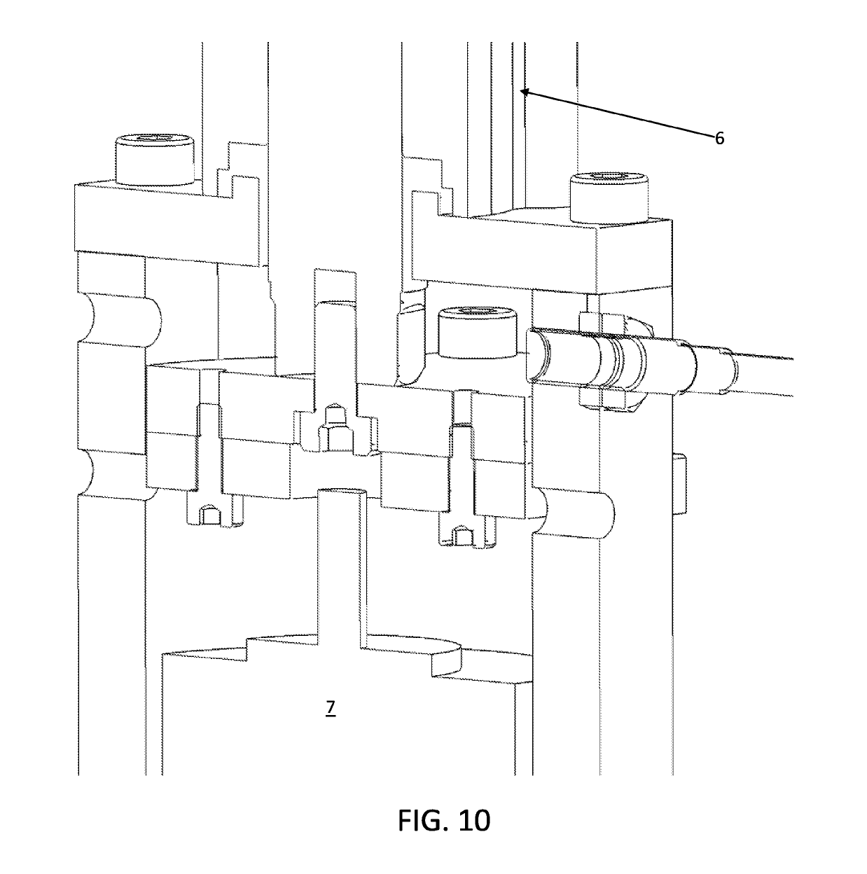

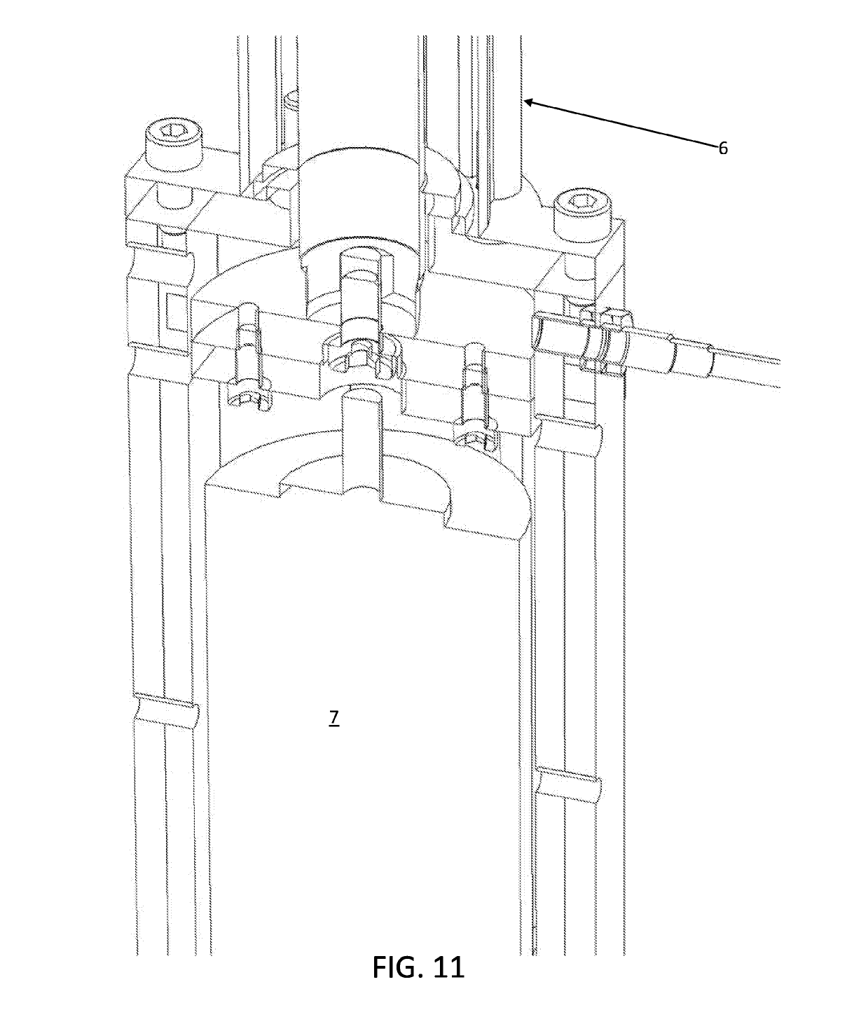

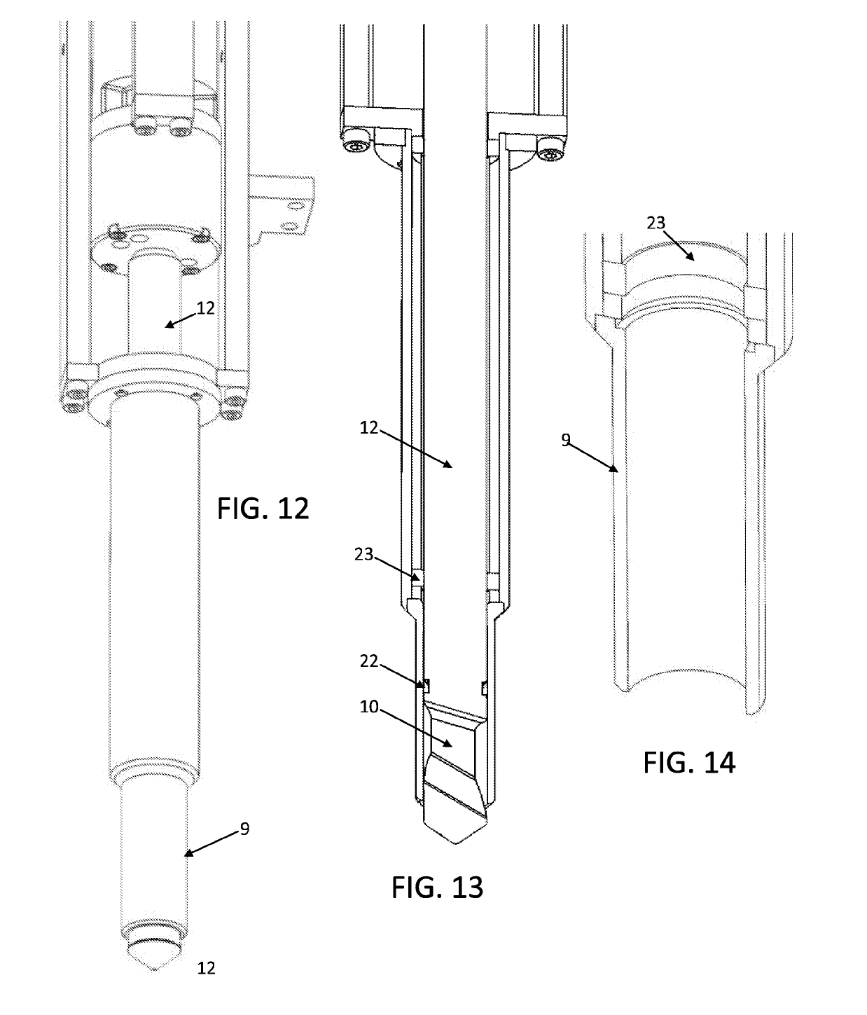

### DETAILED DESCRIPTION OF THE INVENTION

A doser 1 is disclosed. The doser 1 may comprise a linear stepping motor 6, a motor 7, one or more toothed discs 8, and a dosing rod 12 provided with a dosing chamber 10. The dosing chamber 10 may comprise a bottom inclined slope 10A, one or more lower inclined side portions 10B, one or more side portions 10C, and an upper portion 10D. The dosing rod 12 preferably fits within a dosing tube 9, and may be movable with respect to the dosing tube 9, so as to form an adjustable gap 11. The adjustable gap 11 may be varied during various portions of loading, dosing, and cleaning to expose/open or conceal/close dosing chamber 10. A dosing head comprising the dosing tube 9 and dosing rod 12 may be inserted into a cleaning unit 17 comprising a dosing funnel cleaner 2 having one or more dosing funnel cleaner jets 2A, and a dosing head cleaner 3 having one or more dosing head cleaner jets 3A.

The cleaning unit 17 may be further configured to clean a dosing funnel 4. Preferrably, the dosing funnel 4 is configured to ensure that sample material carried by the doser 1 and removed from the dosing chamber 10 is not lost or spilled. A distal end 16 of the dosing funnel 4 may, for example, face or be provided above a sample to be dosed. The cleaning unit 17 may be provided with an exhaust connector 5, such as a tube extending from a portion of the cleaning unit 17. The exhaust connector 5 may be conveniently positioned at a lower portion of the cleaning unit 17 as shown, and may be hooked up to a vacuum or other suction device. A negative pressure differential between the cleaning unit 17 and the vacuum or other suction device may facilitate decontaminating dosing head surfaces.

The doser 1 may comprise one or more bearings 14 disposed within a bearing race 18 to facilitate smooth rotation of motor 7 components and/or toothed discs 8. A fastener 19 may connect a lower toothed disc 8 to the dosing rod 12. Spring means 20, such as a coil spring or one or more spring washers as shown, my be provided between the lower toothed disc 8 and the dosing rod 12 to impart a predetermined axial load between mating toothed surfaces of toothed discs 8. Toothed surfaces may comprise ramped surfaces, for example, in a clockwise or counter-clockwise direction which favors the direction of rotation of motor 7. As the motor 7 turns, the toothed surfaces may “ramp” up and down against respective surfaces creating a “hammering” action that imparts vibrations to the dosing head.

The dosing rod 12 may comprise one or more grooves 21 containing one or more first wiping seals 22 for scraping material which might collect on inner surfaces of dosing tube 9, on outer surfaces of the dosing rod 12, or between dosing rod 12 and dosing tube 9 surfaces. One or more second wiping seals 23 may be further provided to one or more portions of the dosing tube 9 above the one or more first wiping seals 22 (as shown), and/or one or more second wiping seals 23 may be further provided to one or more portions of the dosing tube 9 below the one or more first wiping seals 22 (not shown). Dosing rod 12 may further comprise one or more flats 24 for imparting a torque (e.g., to remove or attach the dosing rod 12 via fastener 19). The dosing rod 12 may comprises a distal frustoconical surface for easy penetration into a material sample to be loaded into the dosing chamber 10. A distal lip 25 may be provided to the distal portion of the dosing rod 12 to a lower toothed disc 8, and/or one or more flared portions or “chamfers” (not labeled) may be provided to distal portions of the dosing rod 12 in combination with, or in lieu of distal lip 25.

In use, the dosing chamber 10 may be partially or fully exposed/opened during material loading, dosing, and/or cleaning steps. Cross-contamination 26 between materials may be reduced via vibration transmission to the dosing rod 12, and air streams provided through the one or more jets 2A, 3A of the cleaning unit 17.

Material may be fed from a dosing chamber 10 through a variable or adjustable gap 11 between a dosing rod 12 provided at a bottom portion of a dosing head, and into a dosing tube 9 surrounding the dosing rod 12. The dosing chamber 10 may be used to collect and temporarily store the material, as well as used to place the temporarily stored material into a desired container or vessel. The accuracy and speed of dosing may be regulated by adjusting the variable gap between the dosing rod 12 and the dosing tube 9, and/or by adjusting the amount of dosing chamber 10 which is exposed from the dosing tube 9. Experimentation with various powder samples may be performed in order to deliver a sample to the dosing chamber in a sufficient amount. Experimentation with various powder samples may be performed in order to determine the dosing performance and defining the dosing accuracy and repeatability. Experimentation with different chemicals in powder form may be performed to determine the carry over possibilities and define one or more cross-contamination levels in % w/w. Computer controllers or automation means (e.g., one or more programmable logic controllers (PLC), CPUs, control systems, etc.) may be advantageously employed with embodiments of doser 1 and/or components thereof, without limitation.

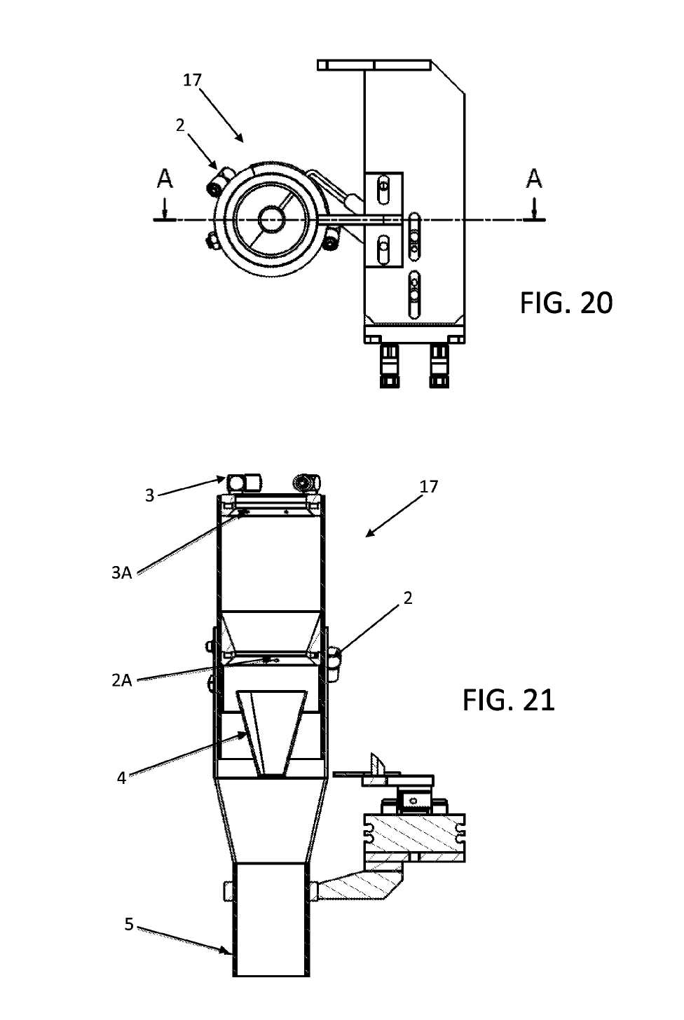

Turning to FIGS. 20 and 21, a cleaning unit 17 is shown. The cleaning unit 17 may be configured for cleaning portions 9, 12 of a dosing head and/or a dosing funnel 4, for example, at the same time. The cleaning unit 17 may comprise one or more rings (e.g., a dosing funnel cleaner 2, and a dosing head cleaner 3) each of said one or more rings comprising one or more air jets 2A, 3A for cleaning respective surfaces of the dosing funnel 4, dosing head, and/or other portions of doser 1, such as dosing rod 12 and dosing tube 9. In some embodiments, the air jets 2A, 3A may be arranged in random, radial, or oblique orientations to form swirling or random air streams within the cleaning unit 17. In some preferred embodiments, the air jets may be asymmetric to create a ‘whirl’ or ‘turbulent’ cleaning effect, without limitation. A dosing funnel 4 may be driven by a rotating pneumatic cylinder so that it is placed inside of the cleaning unit 17 for cleaning and rotated outside of the cleaning unit 17 for dosing.

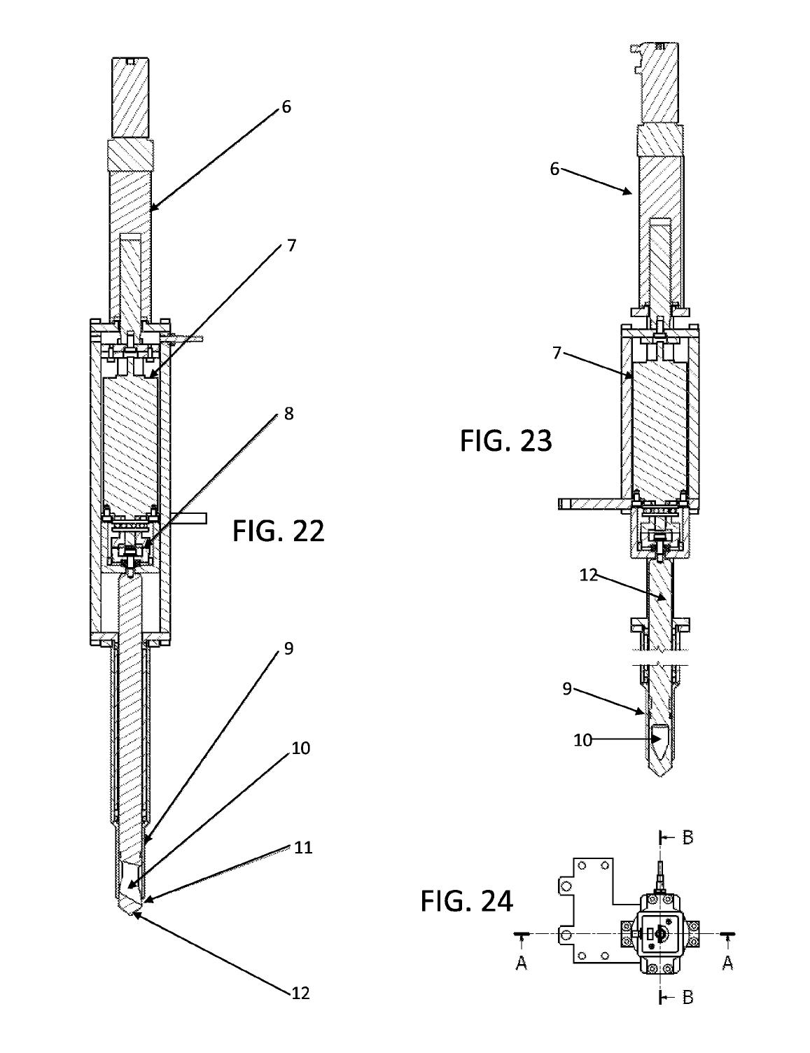

Turning to FIGS. 22-24 a dosing head according to some embodiments is shown. The dosing head comprises a linear stepping motor 6, a motor 7, two mating toothed discs 8 (e.g., an upper toothed disc 8 and a lower toothed disc 8), a dosing tube 9, a dosing rod 12 disposed within the dosing tube 9, a dosing chamber 10 formed between the dosing tube 9 and the dosing rod 12 and being defined by at least one transverse opening within the dosing rod 12, an adjustable gap 11 between the dosing tube 9 and the dosing rod 12 (i.e., measurable in an axial direction along the dosing rod 12 and dosing tube 9), and a distal tip of the dosing rod 12, which may be frustoconical, spherical, rounded, tapered, or blunt in profile. In certain non-limiting embodiments, the linear stepping motor 6 may open the dosing chamber 10 by lifting the dosing tube 9 up, thereby exposing the dosing chamber 10 and dosing rod 12. The dosing head may be moved down so the dosing rod 12 dips into a cup containing sample material or material to be dosed. The motor 7 may rotate with the toothed discs 8 to create vibrations which are transmitted to the dosing rod 12. These vibrations may facilitate transfer of the sample material from the cup into the dosing chamber 10. The linear stepping motor 6 may close the dosing chamber 10 by moving the dosing tube 9 down. The dosing head may be moved up or otherwise away from the cup containing sample material and then moved to a dosing spot to start dosing. Dosing may be performed by opening/exposing the dosing chamber 10 by increasing the adjustable gap 11 in small (e.g., predetermined, measurable, incremental) steps. In some embodiments, the motor 7 with toothed discs 8 are used to provide calibrated or otherwise repeatable vibrations for smooth, predictable dosing.

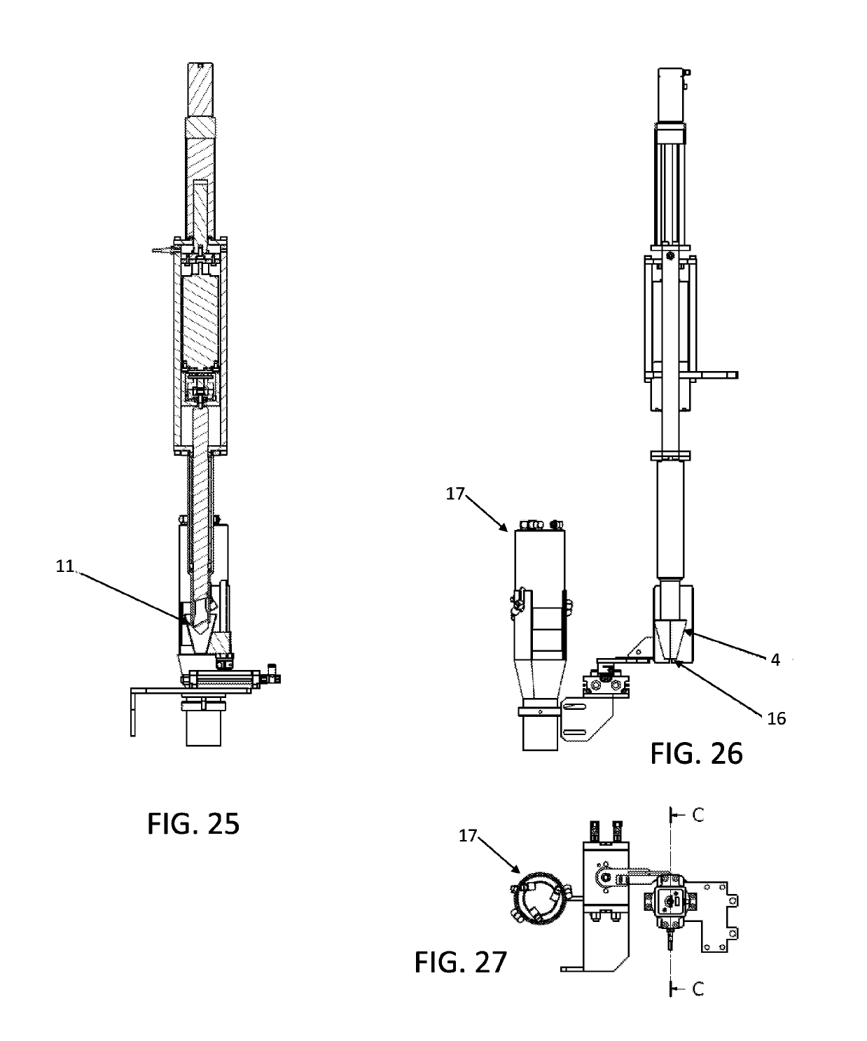

Turning now to FIGS. 25-27, a dosing head cleaning unit 17 assembly is shown, which may be utilized after dosing. A dosing funnel 4 may be moved outside of the cleaning unit 17 into a dosing position. The dosing head (e.g., dosing tube 9 and dosing rod 12) may then be moved above the dosing funnel 4. Dosing may be performed by controlling the opening and/or closing of dosing chamber 10 and/or by controlling vibrations from the motor 7 and toothed discs 8. As the adjustable gap 11 is increased, the dosing chamber 10 is exposed/opened and the sample material slides out of the dosing chamber along a bottom inclined slope 10A and/or lower inclined side portions 10B.

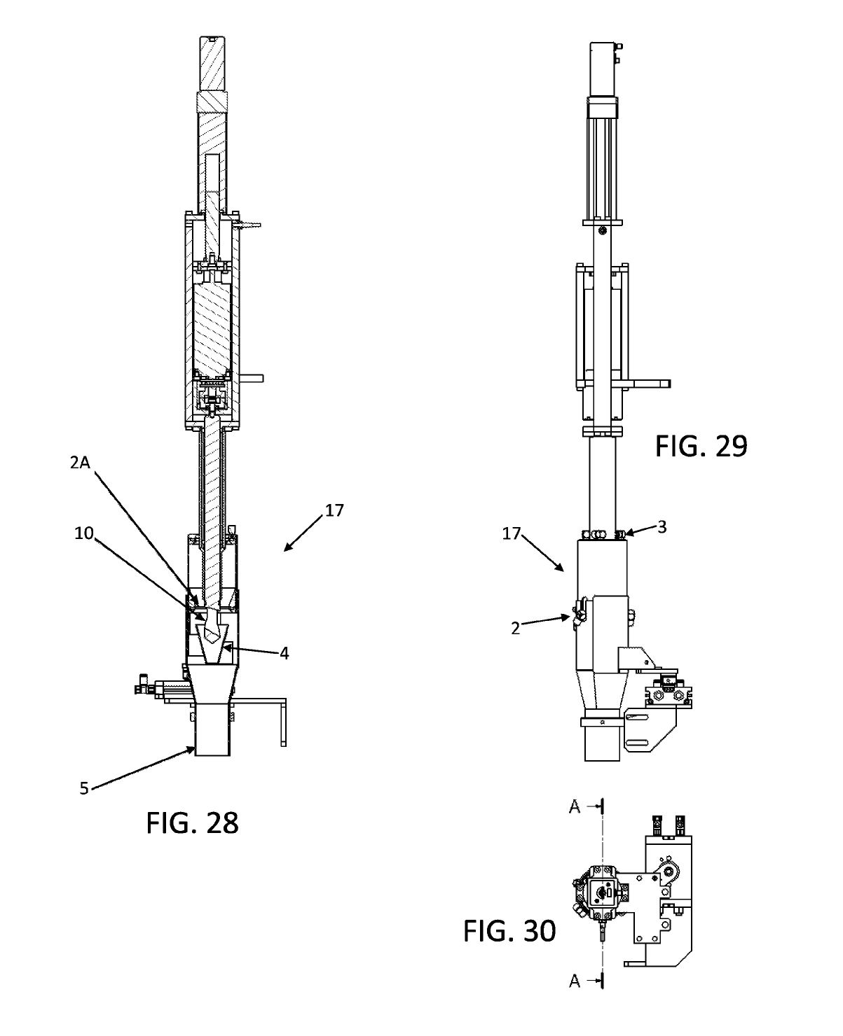

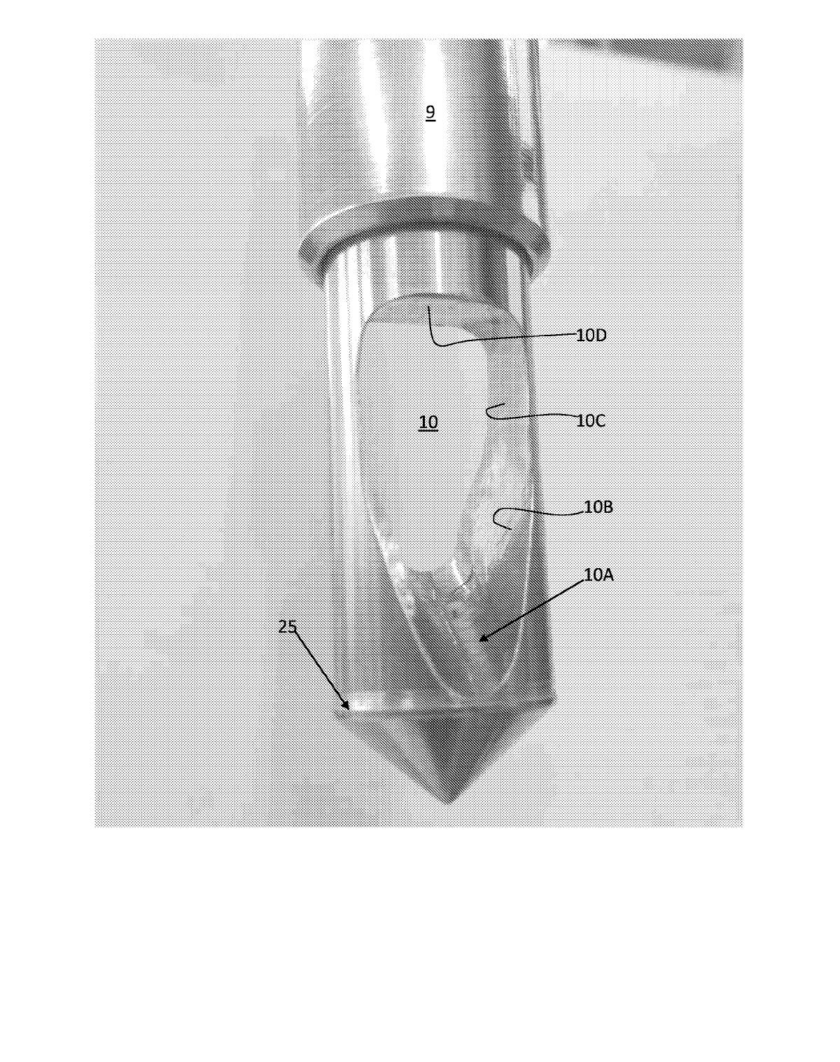

Turning now to FIGS. 28-30, a dosing head and cleaning unit 17 assembly is shown, which may be utilized for cleaning. A dosing funnel 4 may be moved inside of the cleaning unit, wherein de-dusting may take place. For example, one or more air jets 2A, 3A may be turned on. Portions of the dosing head may be moved down inside cleaning unit 17 and the dosing chamber 10 may be fully exposed/opened (e.g., fully extended adjustable gap 11) while vibrating or not vibrating via motor 7 and toothed discs 8. Air streams from the dosing funnel cleaner 2 and/or the dosing head cleaner 3 may be present to clean surface portions of the dosing rod 12, dosing chamber 10, dosing tube 9, surfaces of the dosing head, and/or surfaces of the dosing funnel 4.

### Example 1

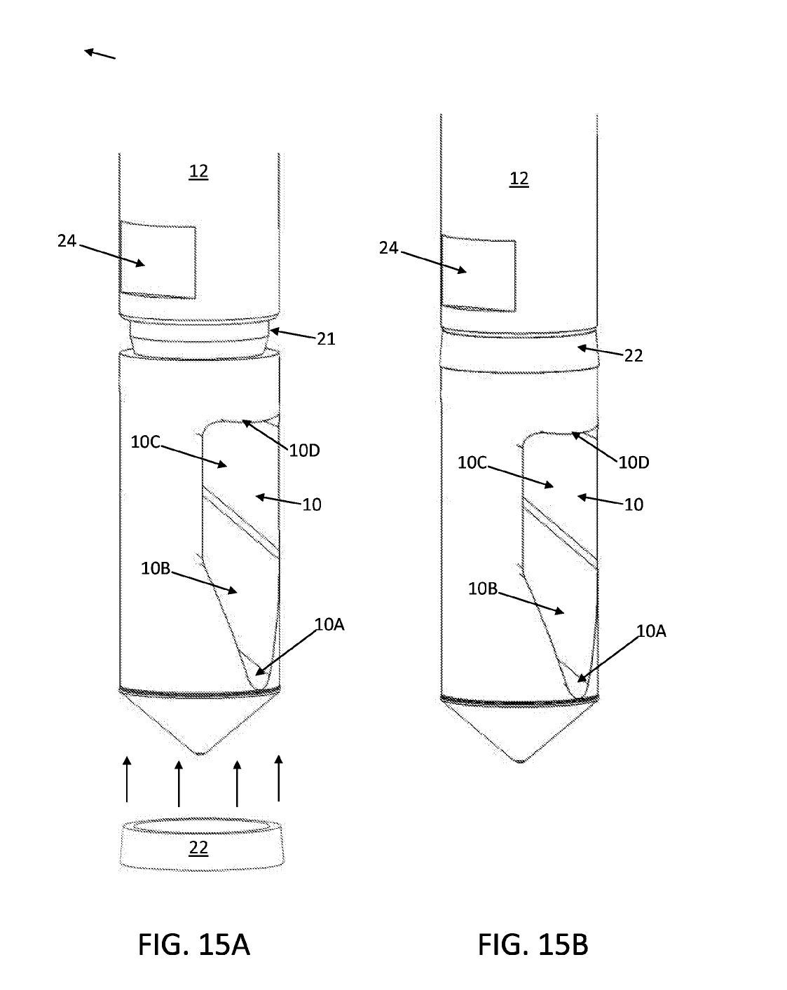

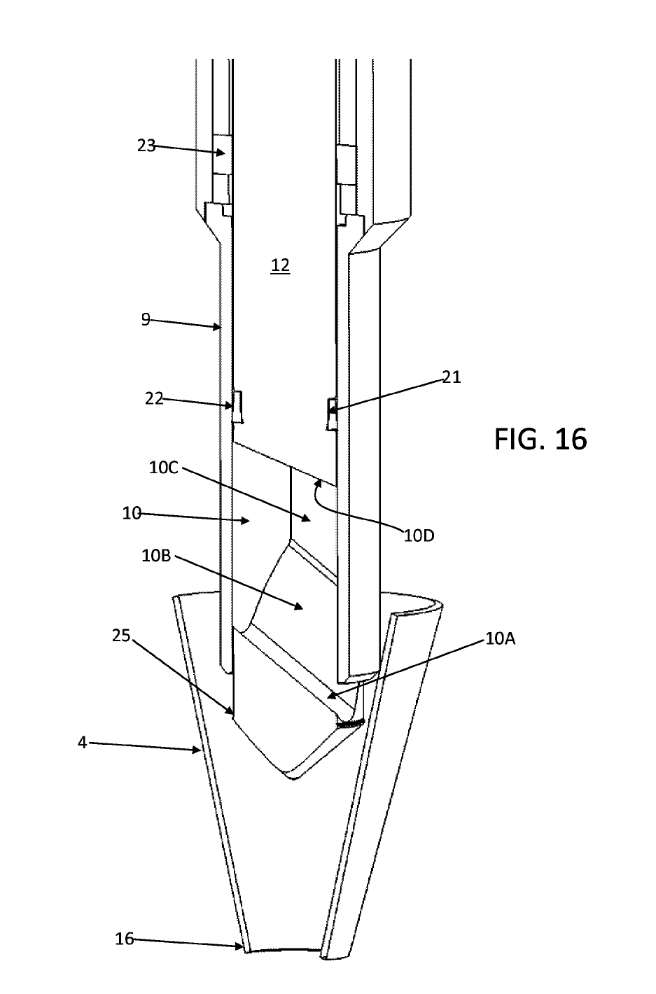

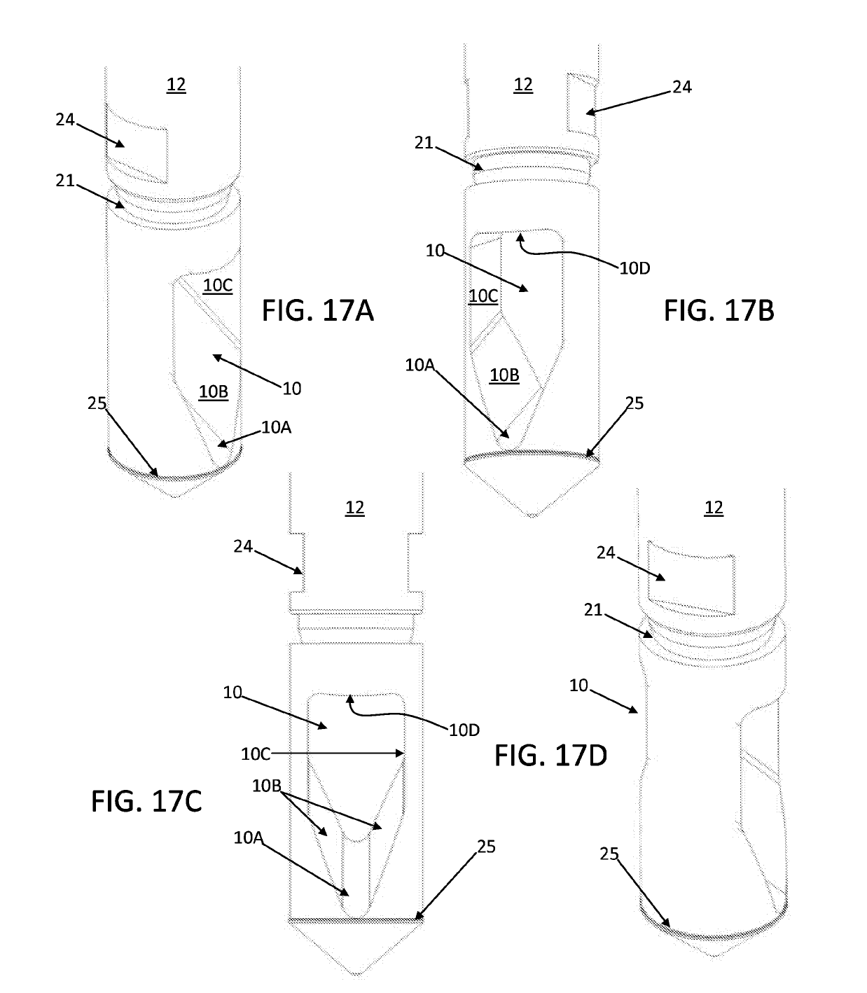

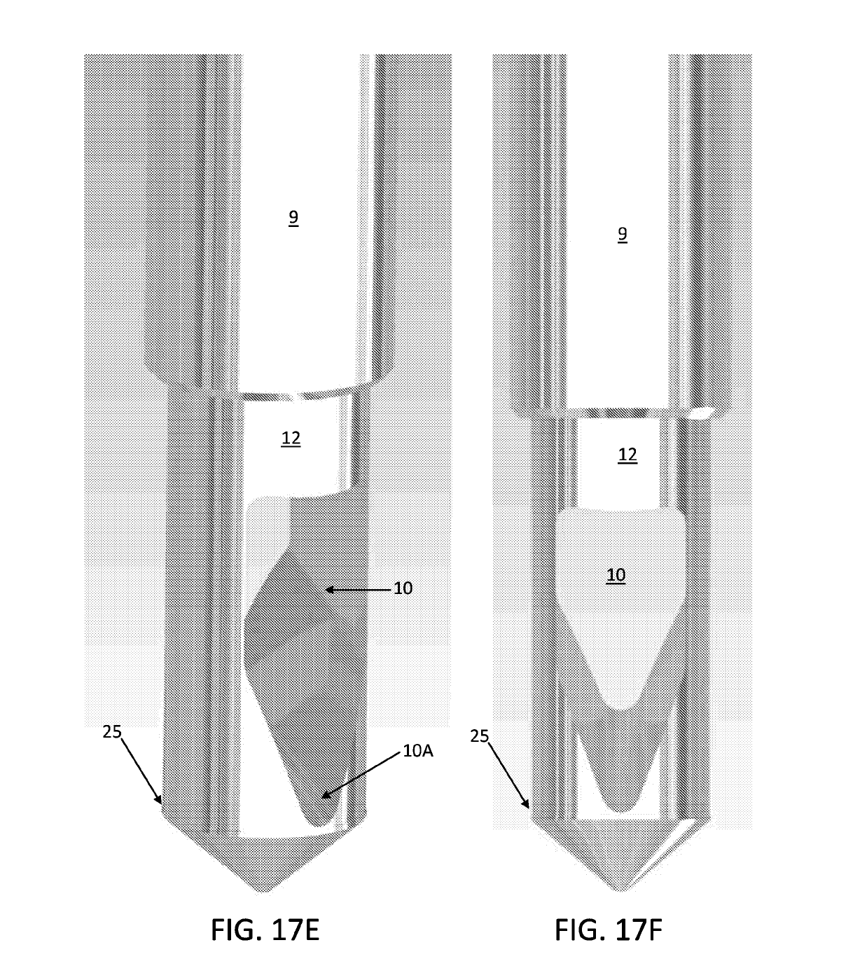

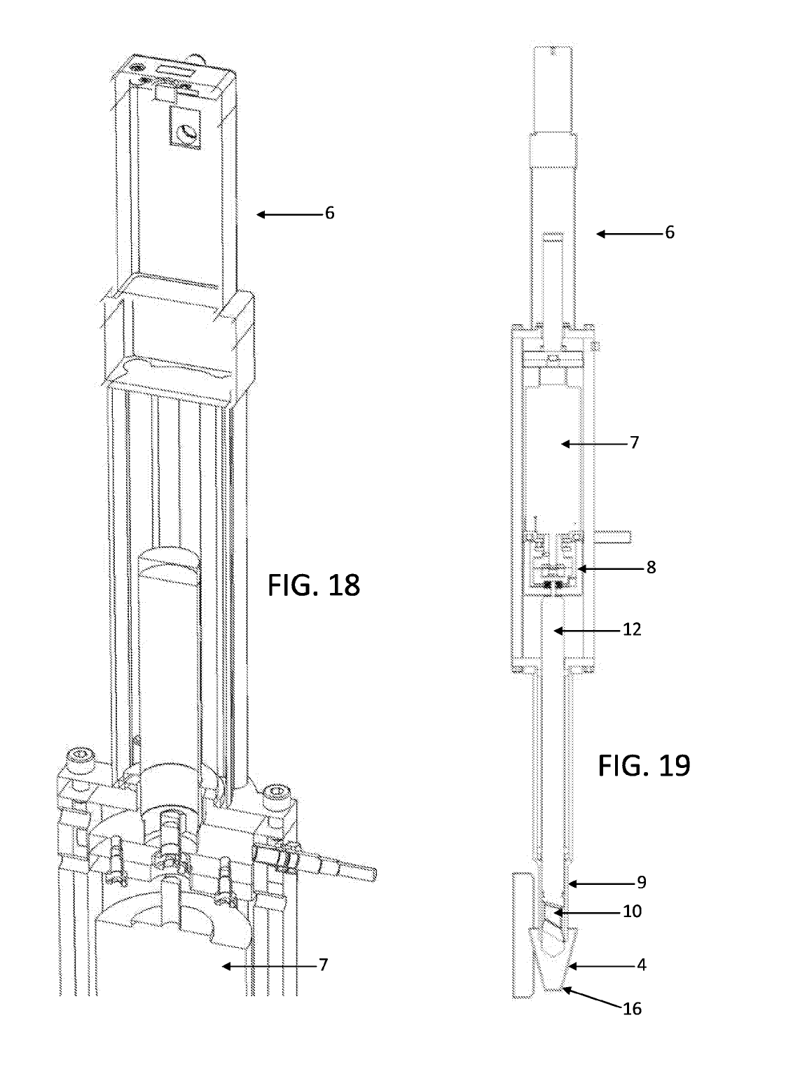

Cleaning efficiency of doser 1 was checked using a visual and pH screening test. The visual inspection showed three major channels of potential contamination risk: a thin coating of very fine particles on the dosing rod 12 portion of the dosing head, fine particles on the distal lip 25 of the dosing rod 12, and fine particle contamination of inner surfaces of doser tube 9. All these sources of contamination were evaluated and risks were decreased by corrective and preventive actions. For example, later experiments employed features such as the first 22 and second 23 wiping seals. The exhaust connector 5 tube diameter was also decreased to increase the velocity of circulating air within the cleaning unit 17, and to increase effectiveness with particle removal. Surfaces were polished to reduce particle “sticking”. The distal lip 25 on the dosing rod 12 adjacent the dosing chamber 10 was reduced to a chamfer. The inner surfaces of the dosing tube 9 were addressed by adding a groove 21 to the dosing rod 12 and adding a first polymeric wiping seal 22, which was provided to and seated within the groove 21 (as shown in FIGS. 15A and 15B). In this regard, the inner surfaces of the dosing tube 9 were better cleaned by the polymeric first wiping seal 22.

Visual inspection of the doser 1 surfaces and/or material in dosing chamber 10 exhibited very limited contamination. Substantially all particles were removed by the first 22 and second 23 wiping seals, and the only contamination exhibited appeared to be a negligible residual micro-coating which possessed an insignificant mass. Also, a post-cleaning pH measurement showed that the total residual material mass on the dosing head after a cleaning step was below 1 mg—with a neutral reaction.

### Example 2

A test was performed to see if there would be any significant cross-contamination from using a dosing head according to embodiments of the invention shown and described herein. The dosing head was utilized in combination with Mammoth™ doser equipment (a dosing device with infeed and outfeed buffer). It was of particular interest to identify any cross-contamination—particularly when the dry cleaning methods described herein (e.g., air streams from within cleaning unit 17, first wiping seal 22, and second wiping seal 23) were applied and/or not applied.

There was no preliminary chemical analysis of contamination. Rather, only a visual inspection of the dosing head surfaces was made prior to performing the test. A cleaning napkin was used to wipe off surfaces of the dosing head after cleaning.

The dosing head was also used for citric acid dosing, and then washed. The rinsing water pH was then measured. In cases of significant contamination a pH value would decrease rapidly. It was found that the first wiping seal 22 for scraping inside portions of dosing tube 9 substantially reduced cross-contamination between different dosing samples. Surfaces of the dosing head (e.g., dosing tube 9, dosing rod 12, etc.) were also polished, which exhibited even better results. Chamfered surfaces were employed adjacent a distal lip 25 on the end of dosing rod 12. Inlet portions of the exhausting pipe 5 were narrowed for higher velocity air extraction. A dosing head from a Mammoth™ doser was utilized, along with a dosing head manipulator (not shown), an air jet pipe exhaust connector 5, and a cleaning unit 17 comprising a dosing head cleaner 3 having dosing head cleaner jets 3A.

Sample materials that were utilized for the test included: granite having a particle size 95%≦10 μm, sinter (dark red) having a particle size 95%≦105 μm, citric acid finely crushed in a mortar, and CaCO₃ having a particle size 95%≦60 μm.

The cleaning unit 17 was constructed of a plastic tube with 6 air jets and an exhaust connector 5 which was connected to a vacuum cleaner for dust removal. The inlet of the exhaust connector 5 tube was configured with a reduced diameter to encourage a higher velocity of inlet air into the cleaning unit 17, and to increase dust removal from doser surfaces. The dosing head was supplied with a polymeric (e.g., plastic) ring (i.e., first wiping seal 22) for scraping, which was designed to remove residual material from inner surfaces of the dosing tube 9, when the dosing chamber 10 is retracted or extended. This first wiping seal 22 was mounted to the dosing rod 12 via a circumferential groove 21 provided in the dosing rod 12 above the dosing chamber 10; however, it is anticipated that a molded-on seal 22, a glued-on seal, a pressed-on seal, or a seal adapted to seat on an annular protrusion or projection (e.g., a radially-extending flange) is envisaged.

To examine the cleaning efficiency of the air streams during dosing head cleaning, the below-mentioned procedure was developed. First, a sampling of the material was taken. Second, the dosing head was retracted to put the dosing chamber 10 within the dosing tube 9 into a closed position. Third, the closed dosing head containing the sampling of material was cleaned in a cleaning unit 17 comprising a pipe provided with air jets 2A, 3A therein. Fourth, the material contained within the dosing chamber 10 was placed into a vessel. Fifth, the whole dosing head including open dosing chamber 10 was placed into the cleaning unit 17, and cleaned by air jets 2A, 3A. Vibrations to the dosing rod 12 were imparted to the dosing head by motor 7 acting in conjunction with toothed discs 8.

A final evaluation of the procedure was made visually. Surfaces of the dosing head and/or dosing chamber 10 were deemed to be “clean”. Additional evaluation was performed after sinter dosing by napkin-wiping the surfaces of the dosing head and dosing chamber 10, and then looking for dark red spots on the napkin which might have been caused from residual sinter. The napkin was also weighed before and after the wiping, to determine the material balance of the contamination.

Chemical fast screening tests were also performed to ensure cleaning efficiency. The tests primarily used changes in pH value to determine contamination. Rinse water pH values were measured in the following manner. The dosing head was cleaned by air jets 2A, 3A within the cleaning unit 17 as previously described. After air cleaning the dosing head was washed by 20 ml of distilled water. The pH value of the water was measured by pH paper strips (i.e., color reaction strips) and compared with reference strips subjected to distilled water as a baseline. The pH value was also recalculated into citric acid concentration (mg/ml) showing approximate amount of the citric acid on the dosing head after air jet cleaning. The main purpose of the test was to indicate, rather than measure an exact value of contamination. XRF analysis tools were utilized to determine exact quantification of contamination.

### Example 3

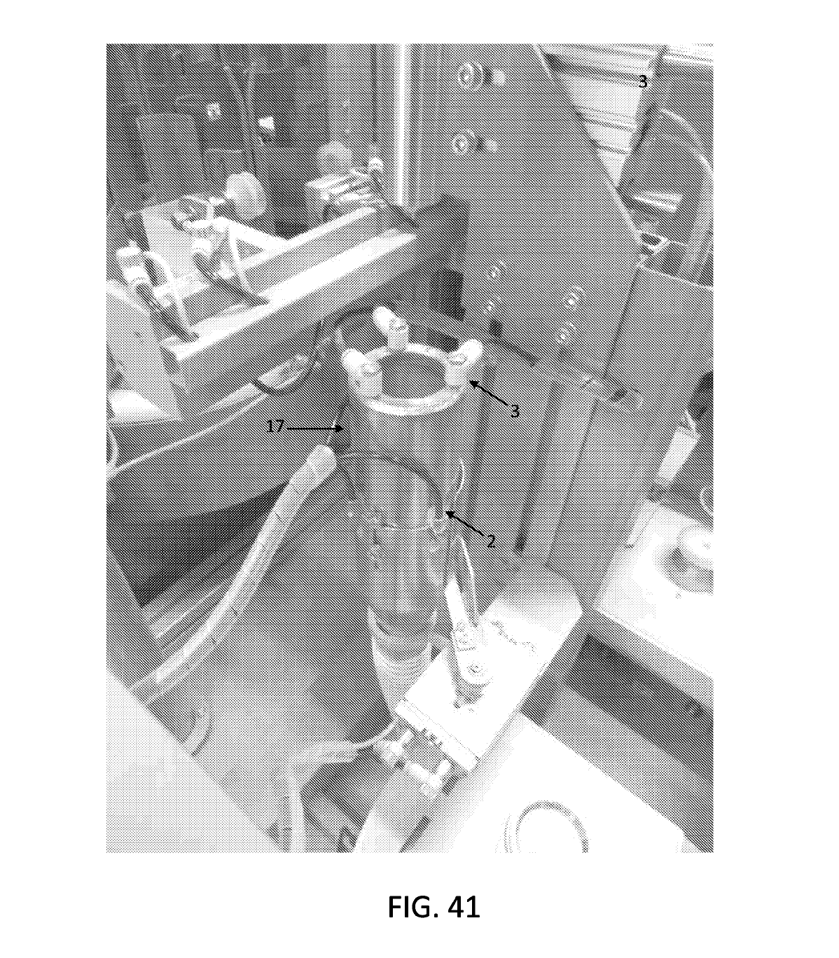

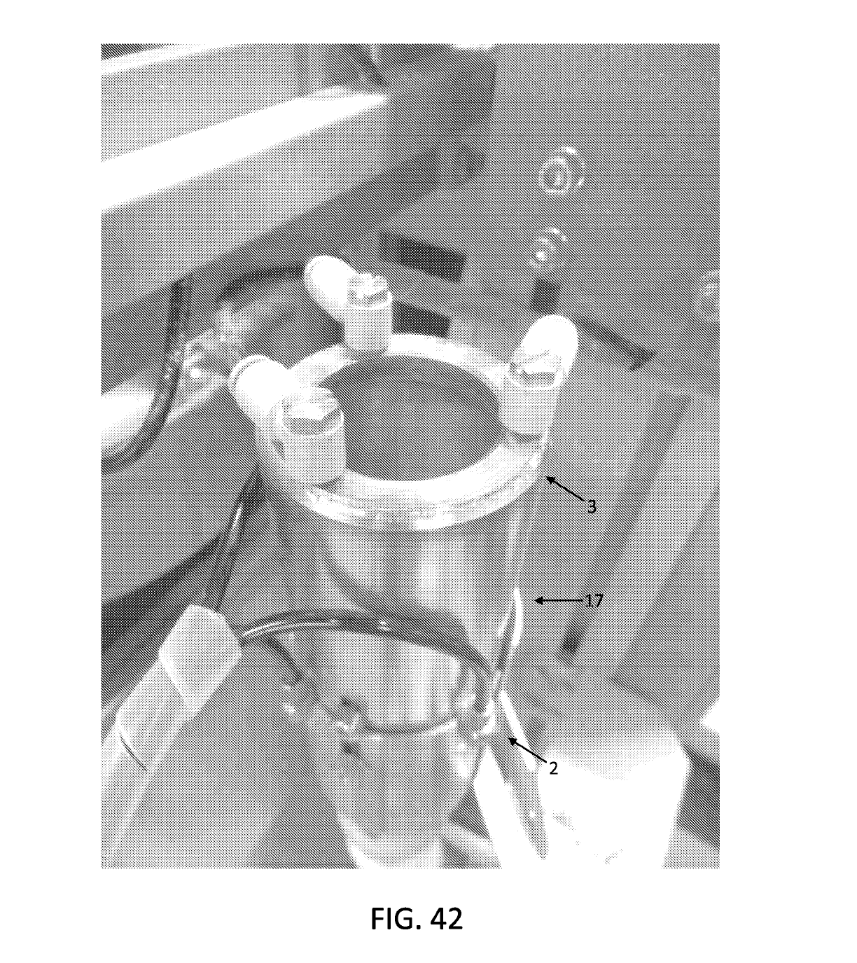

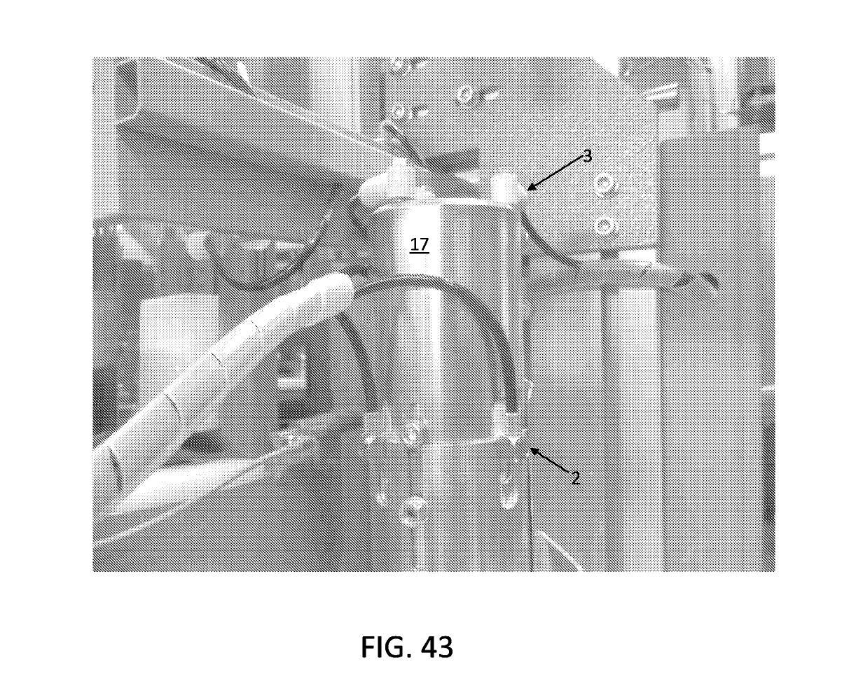

For this test, the cleaning device was adjusted as shown in FIGS. 41-43. Air jets were set-up and adjusted. In particular, 3 jets were set up on top of the vacuum cleaner tube body of the cleaning unit 17, and 3 additional jets were provided below the aforementioned 3 jets. As shown in the figures, a stainless steel material was utilized in the construction of components of the cleaning unit 17.

The aim of the assessment was to determine the degree of contamination of 8 samples supplied by FLSmidth Company labeled with a simple key. The first element in the name indicated a major component of a sample, and the second element in the name indicated one or more contaminants. For example FeCICa would indicate Ferrum (iron) contaminated by Calcium carbonate. Measurements were made by powdered Energodispersive X-ray fluorescence (XRF, EDXRF). Samples were homogenized for 10 minutes in a mortar during all operations. First, spectra of 3 standards supplied were measured for the degree of purity determination and the results were evaluated by a Fundamental Parameters Method (FPM). Analysis of the data revealed that the materials were relatively pure (minor elements contamination was usually below 1%). Only iron standard contained silicon in values below 6%. The contaminated samples supplied were measured and evaluated by FPM. According to the analysis of the results, the range of the calibration curve was chosen. Calibration curves were constructed from standards supplied.

All samples supplied were measured 6 times and the data was evaluated on the basis of constructed calibration curves. The resulting data suggested/implied that the measured contamination through the use of the dosing apparatus described and shown herein was extremely low. At the highest, contamination through the use of the dosing apparatus described and shown herein was still below 0.07% (i.e., for sample CaCIIFe).

In use, the dosing chamber 10 of the dosing rod 12 is extended into a container of sample material, is filled with sample material, and is then retracted into the dosing tube 9 of the dosing head. The dosing head is then moved to the cleaning unit 17, where air jets 2A, 3A within the cleaning unit 17 pipe blow off additional sample material which may have binded or collected onto the dosing head, or which might otherwise be attached to the dosing head. The surfaces of the dosing head may be cleaned by compressed air streams being delivered to the cleaning unit via air jets 2A, 3A. The dosing head may then be moved to a vessel to be dosed. The dosing chamber 10 may then be ejected from the dosing tube 9 of the dosing head, so that the sample contained within the dosing chamber 10 and dosing tube 9 may be dosed into the vessel. In this regard, the dosing chamber 10 may be substantially emptied. Subsequently, the dosing head may be moved back to the cleaning unit 17 so that the dosing chamber 10, dosing tube 9, dosing rod 12, distal lip 25, and other portions of the dosing head may be cleaned by air jets 2A, 3A. It should be noted that air jets 2A, 3A, where used herein, may comprise compressed gasses other than air (for example, inert gasses like nitrogen), without limitation.

While cleaning doser surfaces, the air jets 2A, 3A can clean rough to fine particles fairly easily. During initial tests of early embodiments, there appeared to be some limitations for very fine dust. In such cases, surfaces closest to direct air streams from the air jets 2A, 3A were completely cleaned, whereas other surfaces of the doser 1 were left covered by dust micro-coatings that were visually detected on a cleaning napkin. By narrowing the inlet of the cleaning unit 17, the test results were much better, showing much less post-cleaning fine dust micro-coatings. A preventive effect step of spraying of alcohol (2-propanol) on dosing head surfaces after a predetermined number of (e.g., after every 10) dosing cycles may be practiced in order to further reduce the likelihood of cross-contaminations.

For chemical contamination indication, neutral pH values were found. Removal of the distal lip 25 of the dosing rod 12 showed positive effects in reducing contamination to the dosing head bottom (i.e., a chamfer proved to be better than a ledge). Such results utilizing a chamfer (or “flared” distal end) indicated very low surface contaminations.

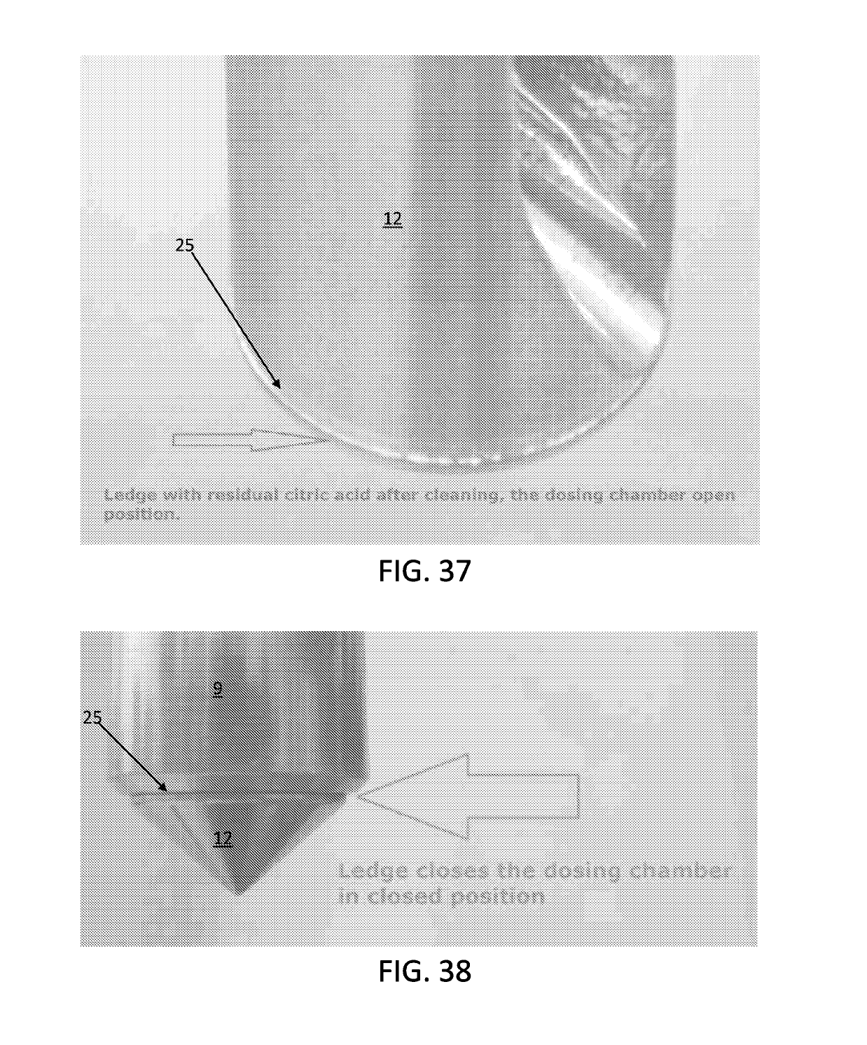

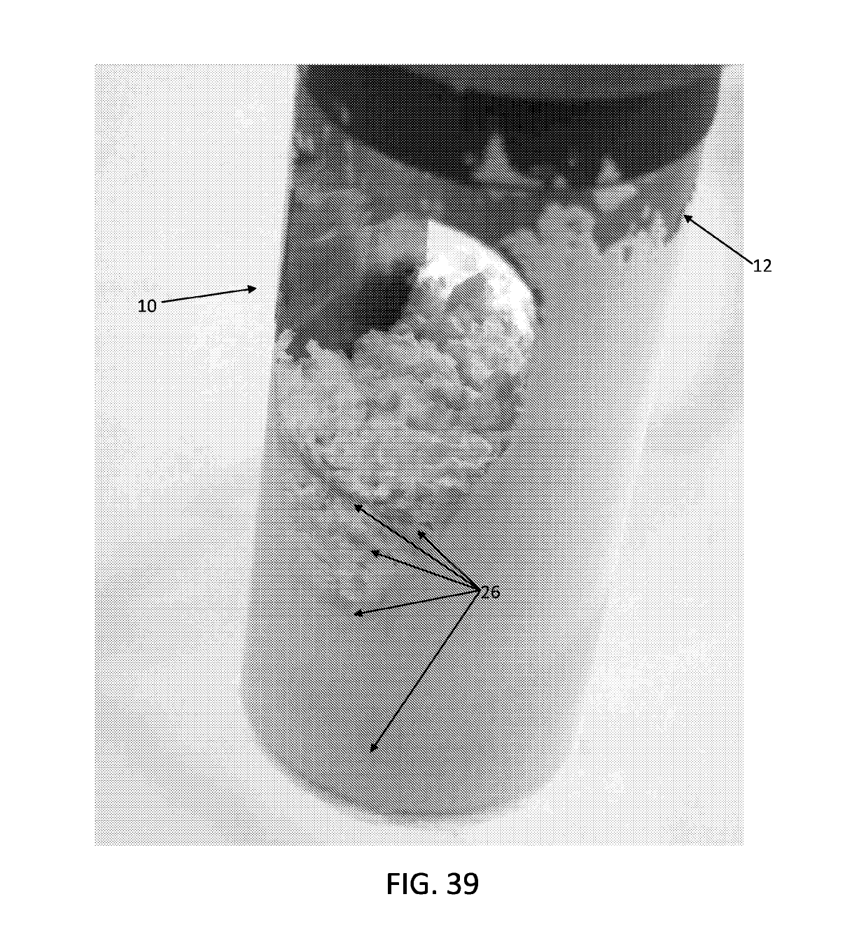

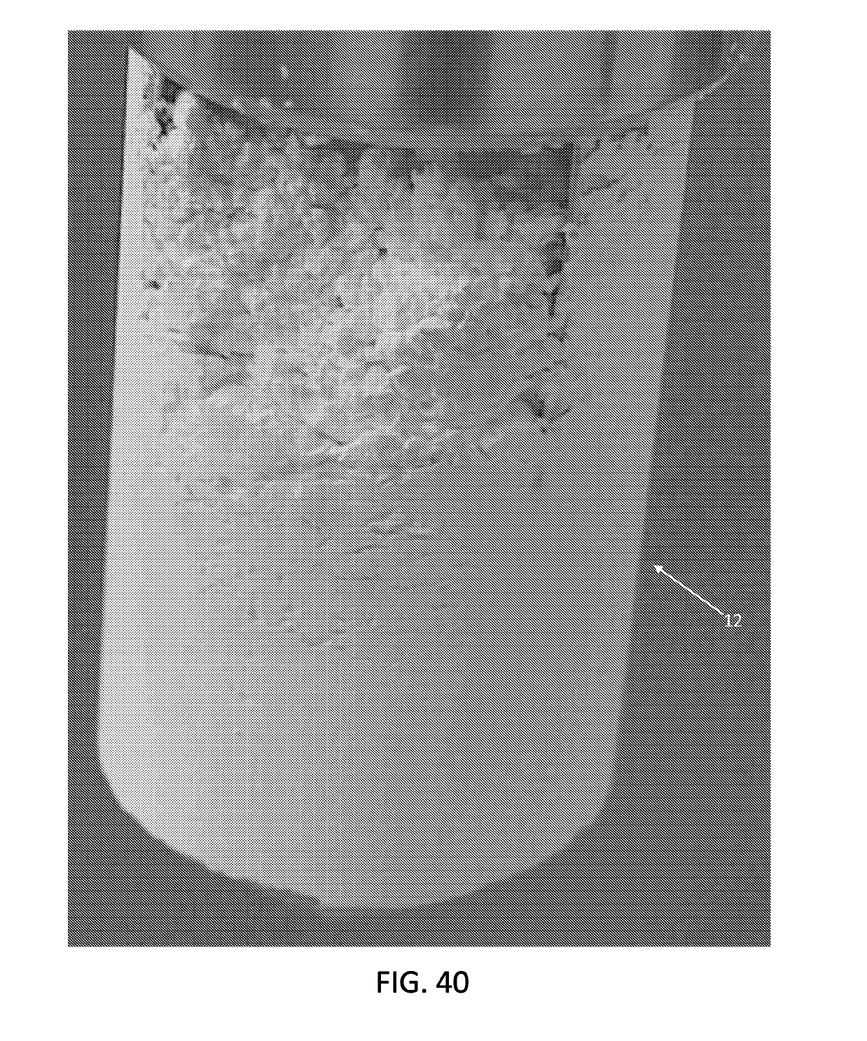

The dosing chamber 10 may be retracted into the dosing tube 9 after material gathering and prior to dosing. This brings potential contaminants to the inner surfaces of the dosing tube 9. Such potential contaminants are generally well-visible, especially in cases where cleaning of inner surfaces of the dosing tube 9 is not performed. With the first 22 and second 23 wiping seals, the contamination of inner surfaces of the dosing tube 9 is significantly suppressed. In some dosing cycles, no visible or apparent contamination was seen on inner surfaces of the dosing tube 9. In some dosing cycles, the contamination was very limited and almost negligible (see FIG. 37). Estimated contamination reduction by using a first wiping seal 22 is estimated to be between 90 and 100%.

The pH measurements obtained through various tests further show that the total residual material mass on the dosing head after cleaning is generally below 1 mg with neutral reaction. Using XRF analysis, further improvements could be still be realized. For example, the exact number(s), location(s), orientation(s), velocity(ies), temperature(s), humidity(ies), and content of the gasses used in air jets 2A, 3A may be varied to improve performance and reduce contamination even further. Moreover, the direction of air stream from jets 2A, 3A may be changed to further improve the removal of finest particles during cleaning cycles. Moreover, the material, shape, clearances within groove, and size of the first 22 and/or second 23 wiping seal may be altered or tweaked for even better scraping efficiency and best contamination removal. The particular shapes, designs, and relative clearances between components may further be optimized. For example, the housing of the cleaning unit 17 may be optimized with computational fluid dynamics (CFD) for maximum fine particle removal.

According to some embodiments, a cleaning unit 17, 117 may comprise a gas and/or liquid cleaning apparatus which is configured to perform one or more sequential gas and/or liquid cleaning steps. For example, in some preferred embodiments, the liquid may comprise wash water and/or a solvent, such as alcohol, without limitation.

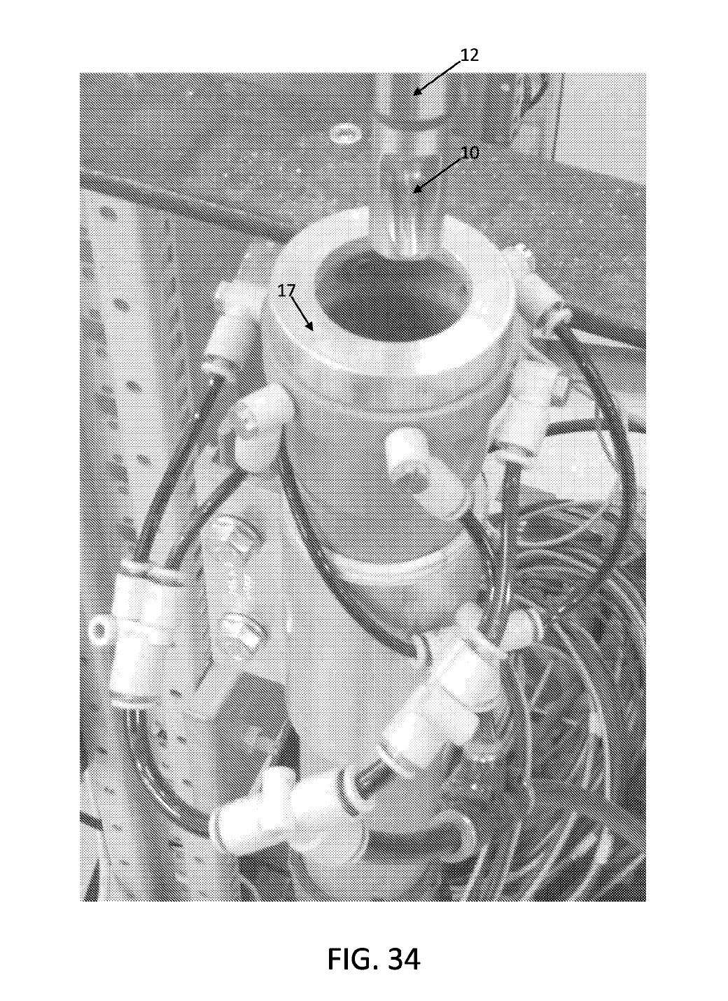

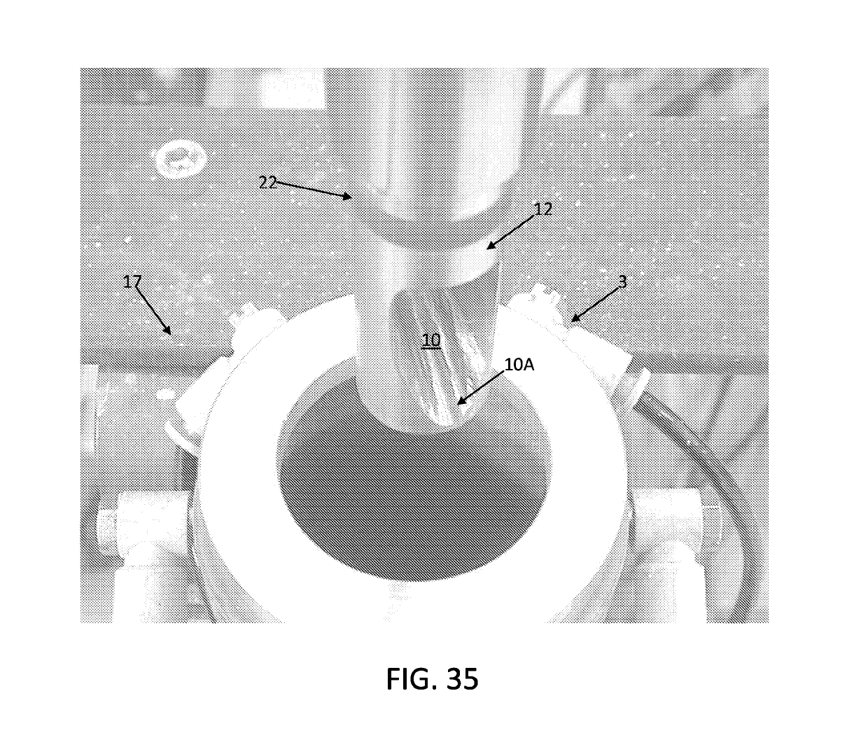

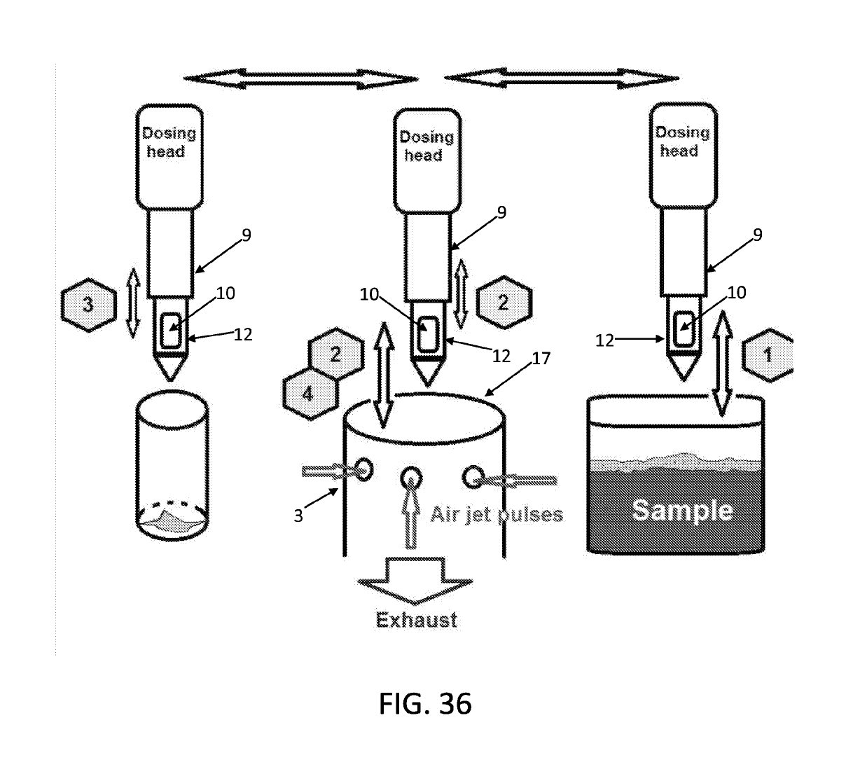

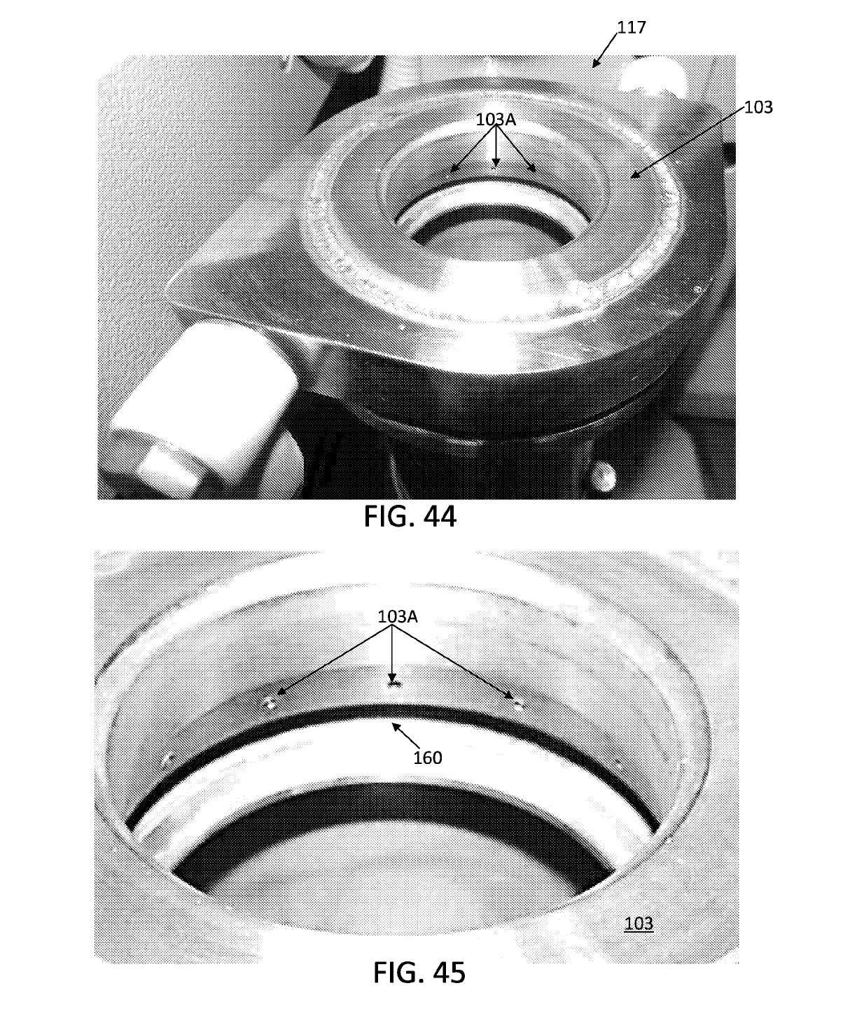

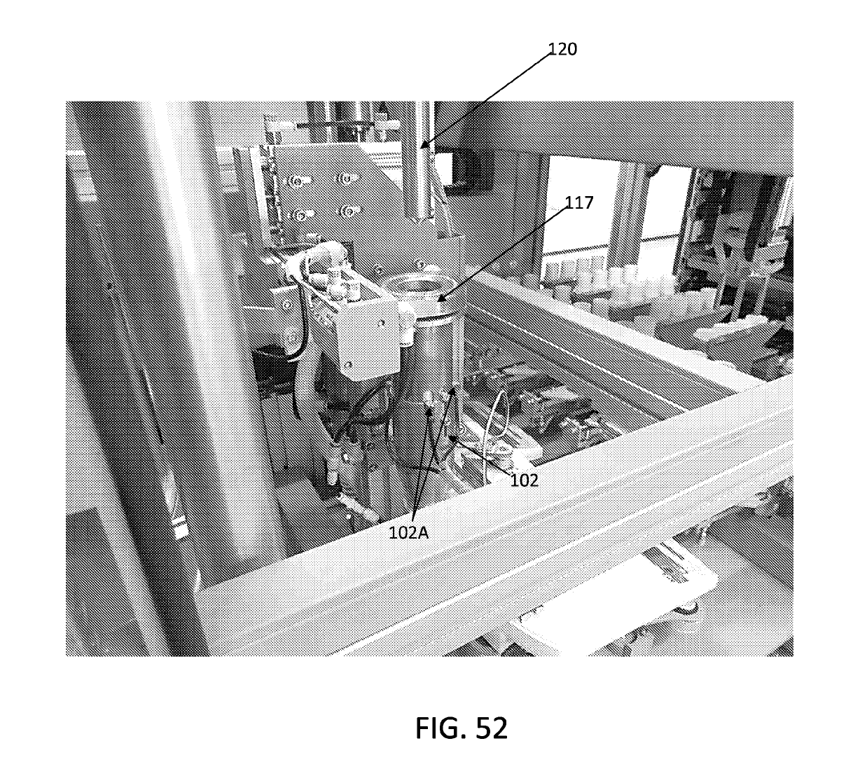

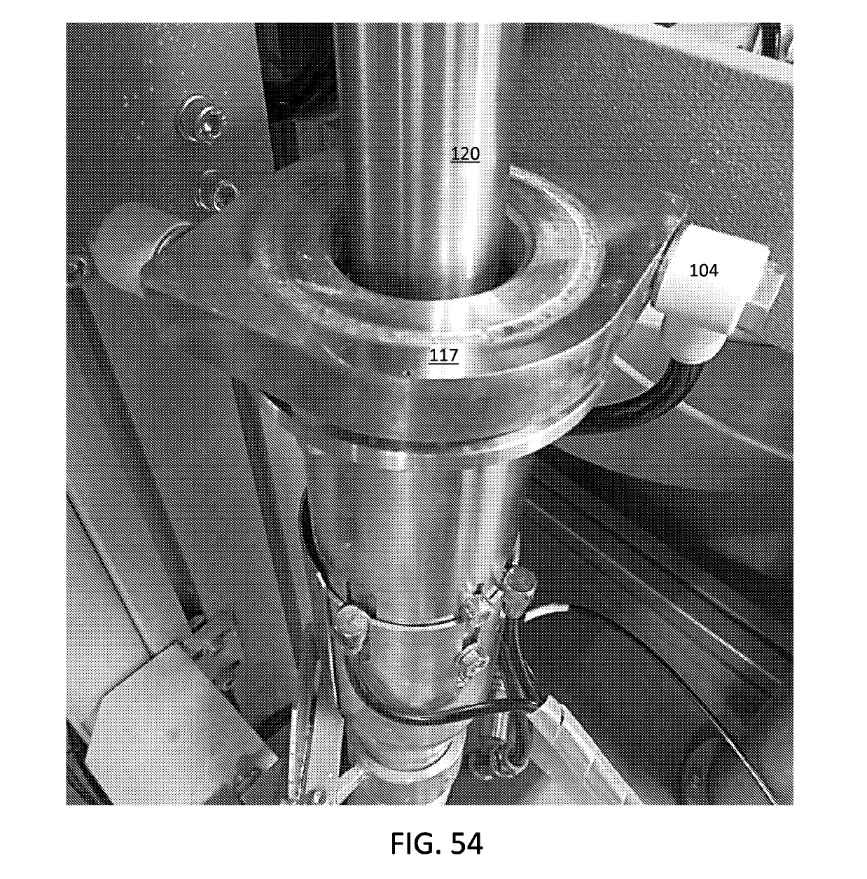

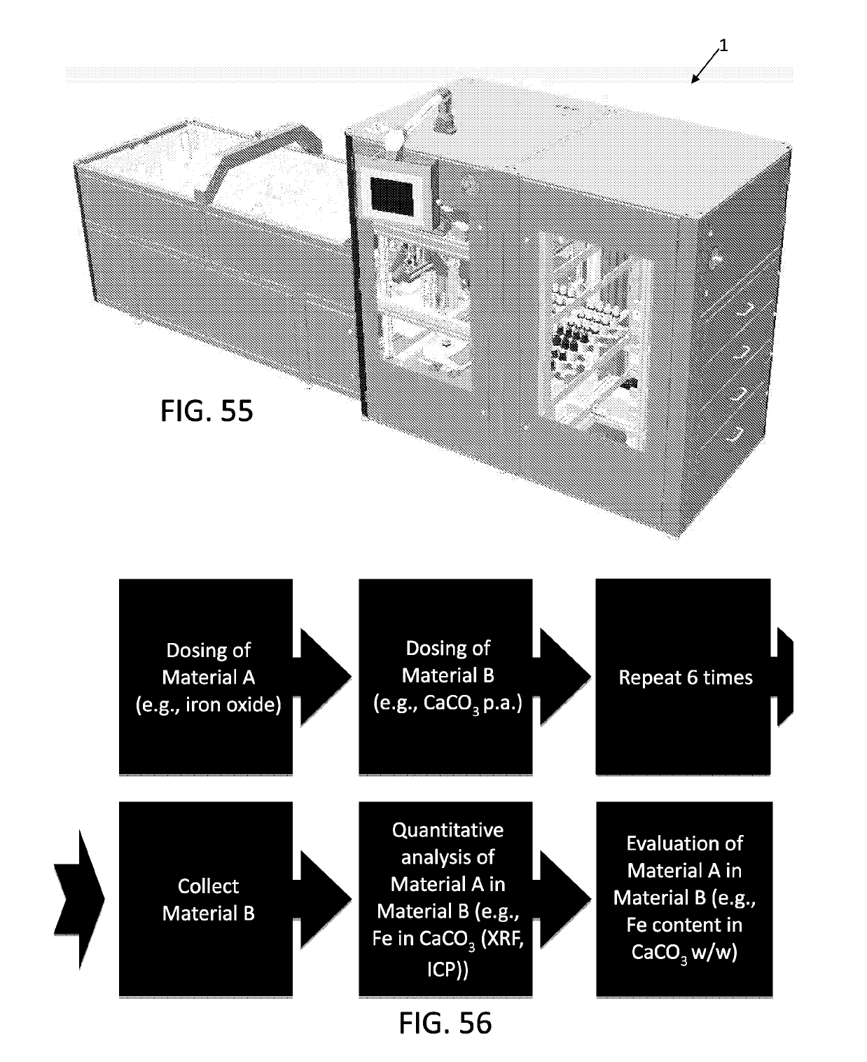

Turning now, to the embodiments shown in FIGS. 44-54, a cleaning unit 117 may be provided with liquid cleaning means, which may employ a gas, such as compressed air, without limitation. The liquid cleaning means may be configured to clean a dosing rod 12, for example, via a number of air and/or alcohol jets. The conceivable number of jets 103A may vary according to various embodiments; however, as shown in the exemplary embodiment of FIG. 45, twelve (12) air/alcohol jets 103A may be provided, without limitation. The number of jets 3A shown in FIG. 34 is six (6), for comparison. The jets 103A may be configured and/or oriented in various directions to maximize cleaning a dosing rod 12, without limitation. The jets 103A may be, for example stacked in vertically spaced annular rows, aligned vertically in columns, staggered in various directions, aligned in various directions, arranged randomly, or provided in one or more annular configurations, such as the symmetrical annular configuration shown clearly in FIG. 45.

According to some non-limiting embodiments, air may be released from one or more jets 103A. According to some non-limiting embodiments, alcohol may be released from one or more jets 103A. According to some non-limiting embodiments, wash water may be released from one or more jets 103A. According to some preferred embodiments, at least one, some, or all of the jets 103A may release a stream of a mixture of air and alcohol, without limitation.

According to some envisaged embodiments, jets 103A may emit different streams. For example, a first jet 103 may release air, a second jet 103A may release alcohol, and a third jet 103A may release a combination of air and alcohol. In such envisaged embodiments, jets 103A may be activated simultaneously, or independently, for example in a predetermined sequence.

According to some preferred, non-limiting embodiments, for each cleaning cycle, approximately 3-5 milliliters of liquid (e.g., alcohol, solvent, or liquid mixture) may be consumed, without limitation. In other words, 3-5 milliliters of liquid may be sprayed from one or more jets 103A per cleaning cycle, without limitation.

According to some preferred, non-limiting embodiments, each cleaning cycle (which may include liquid washing) may last for between about 0.1 and 120 seconds; for example, between about 1 and 60 seconds, or between about 1 and 20 seconds, or between about 5 and 15 seconds (e.g., approximately 9 or 10 seconds), without limitation. It should be understood that cleaning cycle times may vary between materials, may vary depending on the type(s) of materials being dosed, and may be increased or decreased as necessary, depending on the material types. It should also be understood that one or more cleaning cycles may be sequentially repeated a number of times, without limitation.

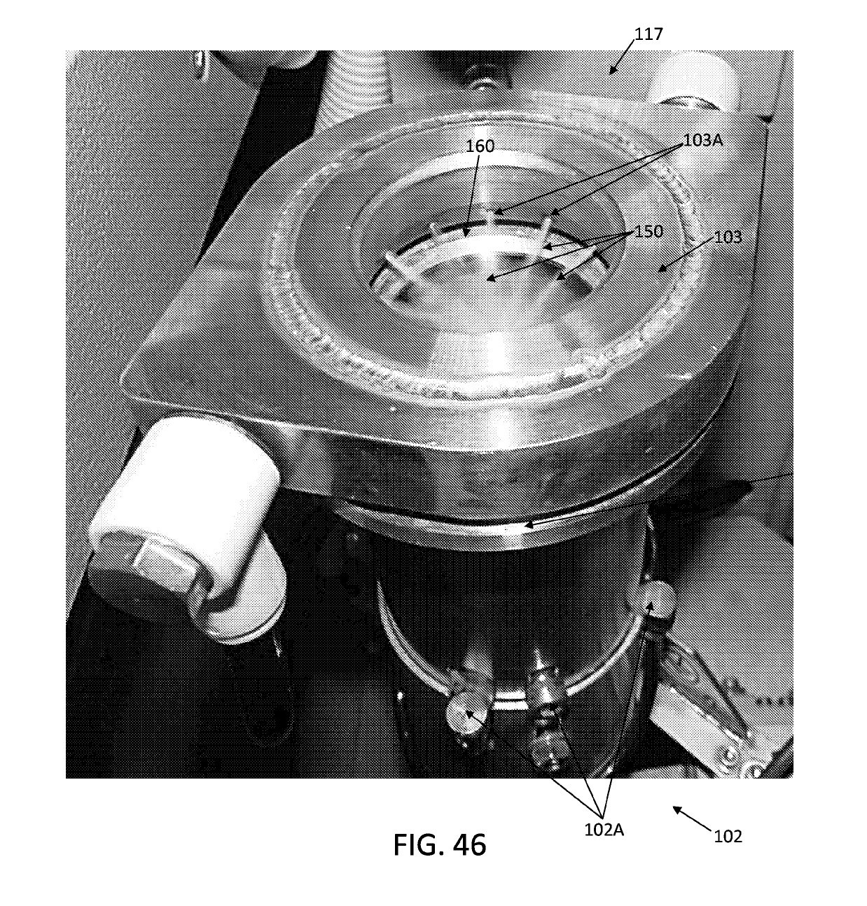

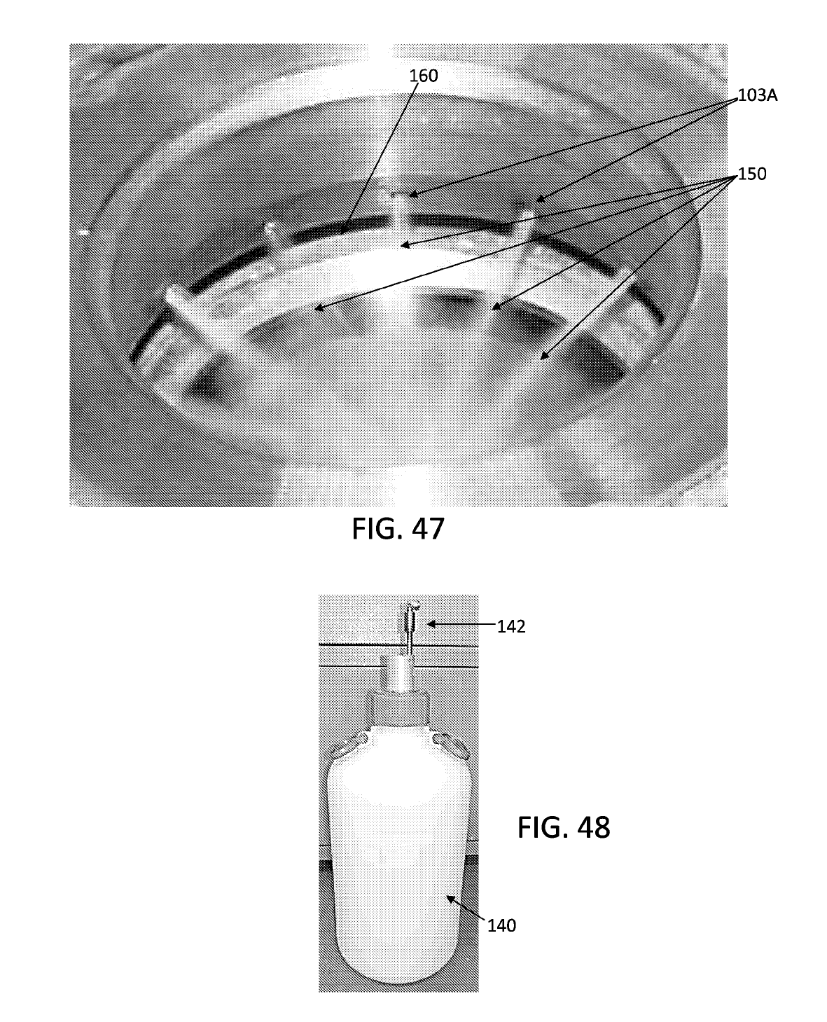

According to some preferred, non-limiting embodiments, the cleaning unit 117 system may be configured to accommodate a variety of liquids, such as wash water, a solvent, a combination of one or more solvents, a combination of one or more solvents and wash water, and/or the like, without limitation. A liquid component may be combined with one or more gaseous components (e.g., air, nitrogen) in a mixing chamber 170 prior to being emitted from the one or more jets 103A. In some preferred embodiments, the cleaning unit 117 and vessel 140 may be preferably designed to accommodate the use of isopropyl alcohol for good results, although other types of solvents and combinations of solvents are anticipated. In the particular embodiment shown in FIGS. 46 and 47, the cleaning unit 117 is shown spraying a mixture of isopropyl alcohol and compressed air which have been pre-mixed in a mixing chamber 170, through jets 103A. Obviously, one or more other solvents could be advantageously utilized, and one or more other types of gasses may be used (e.g., nitrogen).

According to some embodiments, liquid cleaning means of the cleaning unit 117 may further be provided with a liquid holding vessel 140, such as a vessel for storing wash water and/or alcohol, without limitation. According to some embodiments, the volume of the vessel may be between 1 and 200 liters, without limitation. As shown in FIG. 48, a vessel may be approximately 25 liters. However, the vessel may be larger, or smaller, for example, depending on anticipated machine run time, wash cycle time, and flowrate through the one or more jets 103A.

Cleaning means provided to cleaning unit 117 may further comprise an open, partially-enclosed, or enclosed box 130, which may comprise one or more pumps 135, according to some embodiments. The box 130 may be covered to reduce evaporation, and may comprise one or more breather devices to eliminate vacuum buildup. It is anticipated that the one or more pumps 130 may be provided without a box 130; for example, one or more pumps 135 may be provided as sumps in vessel 140, which pump a predetermined amount of liquid from the vessel 140 directly into a mixing chamber 170. The one or more pumps 135 may be configured to move liquid (e.g., wash water and/or alcohol solvent) from the liquid holding vessel to the one or more jets 103A, according to some embodiments. In some preferred embodiments, the pumps 135 may be alcohol pumps.

According to some embodiments, a box 130 may be provided. The box 130 may be a housing configured to hold liquid, and may be provided as a pump box which may comprise the one or more pumps 135 therein. Preferrably, the one or more pumps 135 may be configured to pump a liquid from the box 130 to a mixing chamber 170, without limitation. The one or more pumps 135, for example, may be configured to pump alcohol to the mixing chamber 170, without limitation. The one or more pumps 135 may be positioned inside the dosing unit, for example, placed on a level surface, placed on a balanced level, or placed on a scale, without limitation.

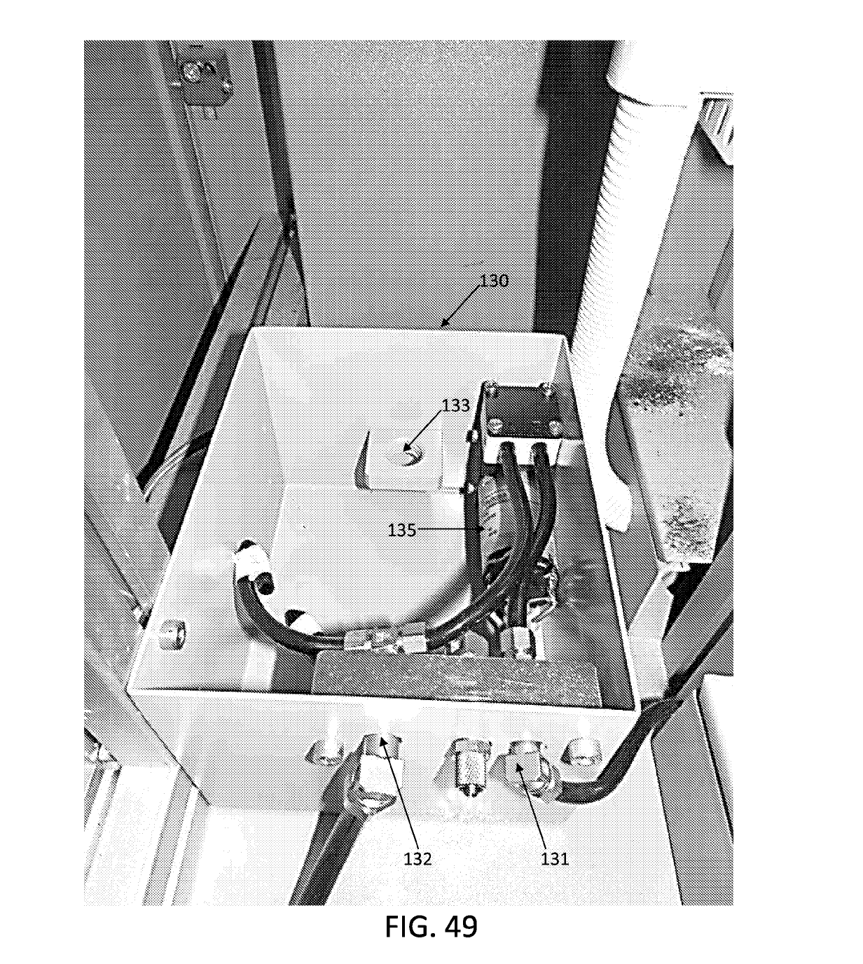

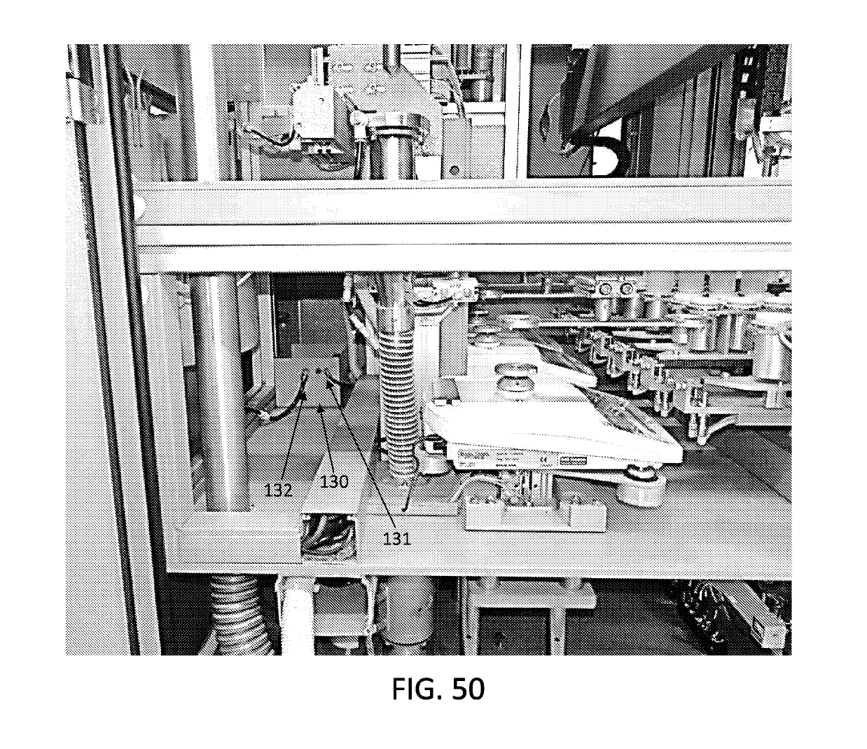

As shown in the figures, a pump box 130 may only be provided with one liquid pump 135. However, it is envisaged that one or more additional pumps 135 and/or one or more optional safety sensors (not shown for added visibility and clarity) may be employed, without limitation. For example, one or more safety sensors may be mounted to one or more safety sensor mounts 133 of the box 130, for example, in order to avoid situations of liquid within the box 130 overflowing. If provided, one or more safety sensors may be configured to check for alcohol leakage or overpumping. For example, in the event that liquid (e.g., alcohol) appears on the bottom of the box 130, or if liquid (e.g., alcohol) level rises, a safety sensor may be configured to, in conjunction with a control unit, stop the pumping operations of the at least one pump 135, without limitation. As suggested by the particular embodiment shown, the one or more pumps 135 may comprise a KNF NF 30 TTDC pump, without limitation. According to some non-limiting embodiments, a safety sensor may comprise an IFM KG5043 safety sensor, without limitation. FIGS. 49 and 50 show a potential positioning of a box with liquid/alcohol pumps 135, according to some embodiments. As shown, the box 130 may be placed inside a weighing module, without limitation.

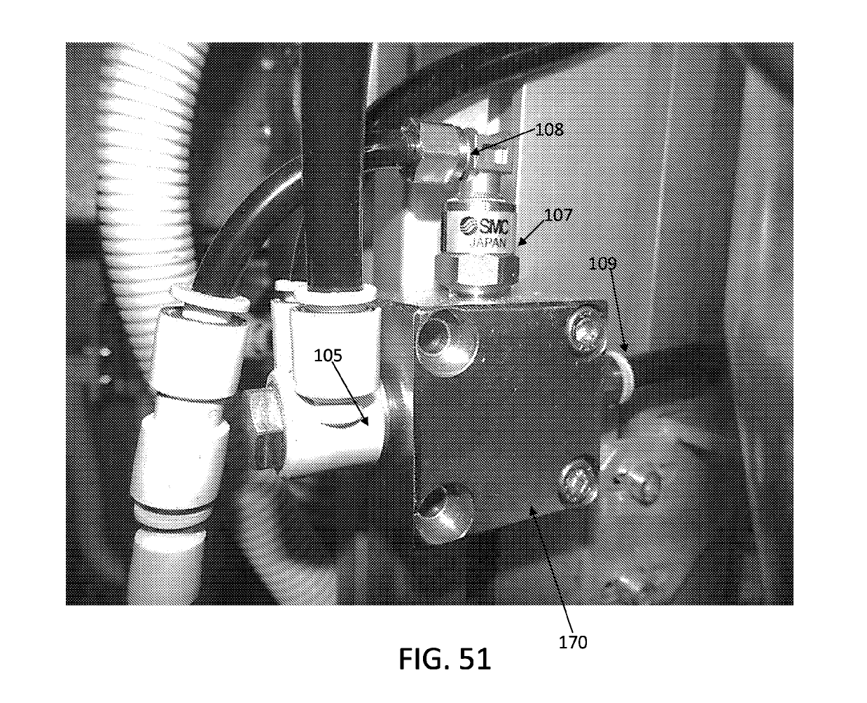

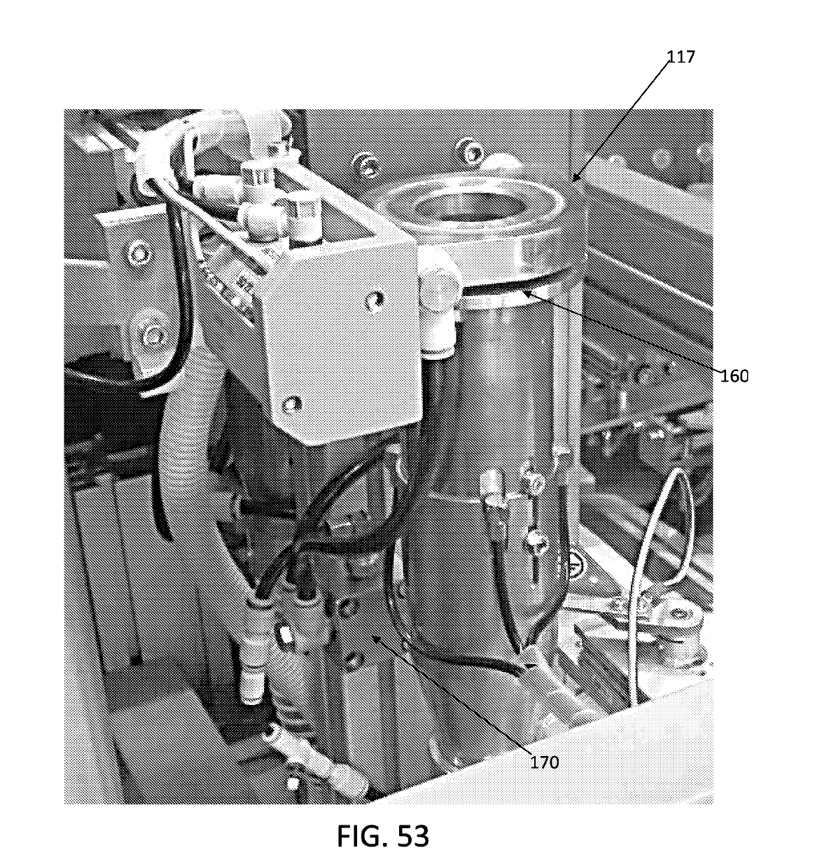

One or more mixing chambers 170 may be provided as cleaning means so as to provide a region mixing. For example, a mixing chamber 170 for mixing a gas and a liquid (e.g., air and alcohol), a liquid and a liquid (e.g., alcohol and wash water), and/or a gas and a gas (e.g., air and nitrogen) may be provided according to some embodiments. According to some embodiments, such as the embodiment shown, a mixing chamber 170 may be designed for mixing a gas (e.g., air and/or other gas, such as nitrogen) with a liquid (such as a solvent like alcohol, wash water, or a combination thereof), without limitation, prior to spraying the mixture through jets 103A. In some embodiments, the mixing chamber 170 may be preferably made of stainless steel and may preferrably mix compressed air and alcohol. FIGS. 51 and 53 show potential positioning locations for a mixing chamber 170, according to some embodiments. As shown, the one or more mixing chambers 170 may be placed inside a weighing module of a dosing machine 1, without limitation.

A one-way valve 107 (e.g., an SMC AKB01B-01AS one-way valve as shown) may be provided to prevent backflow of mixed gas(es) and/or liquid(s) from backing into the pump box 130 and/or liquid holding vessel 140, without limitation. This may be appreciated from FIG. 51.

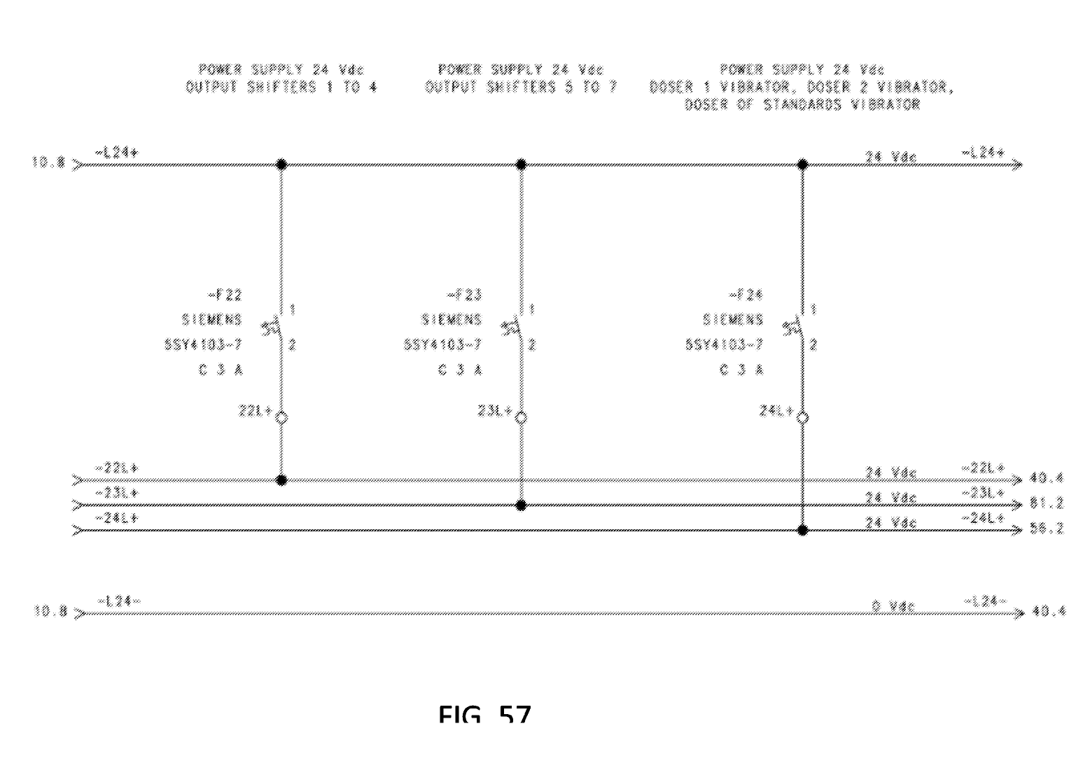

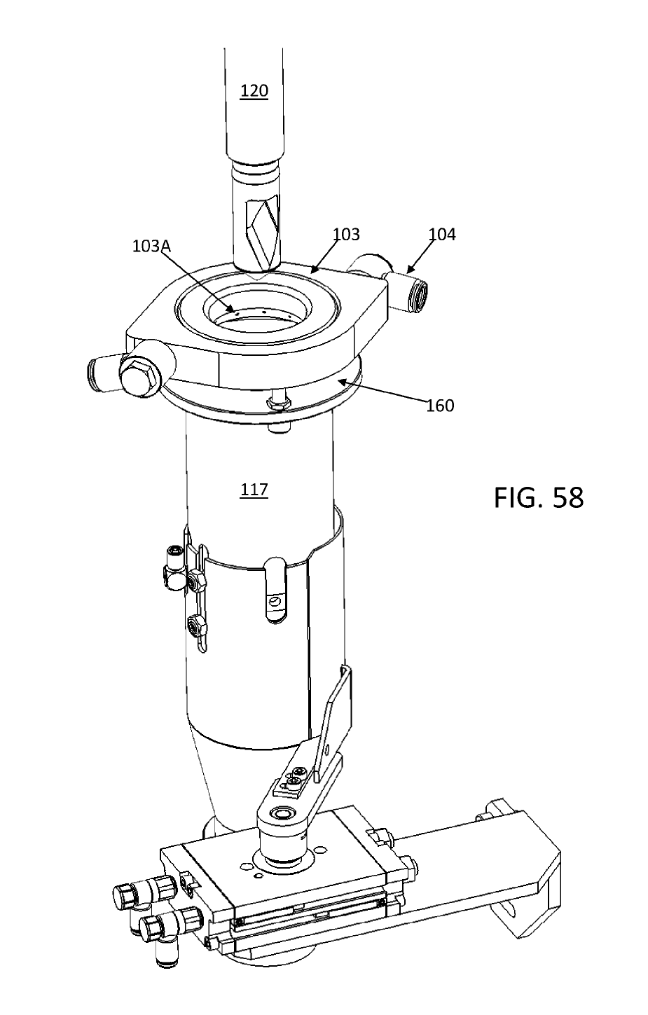

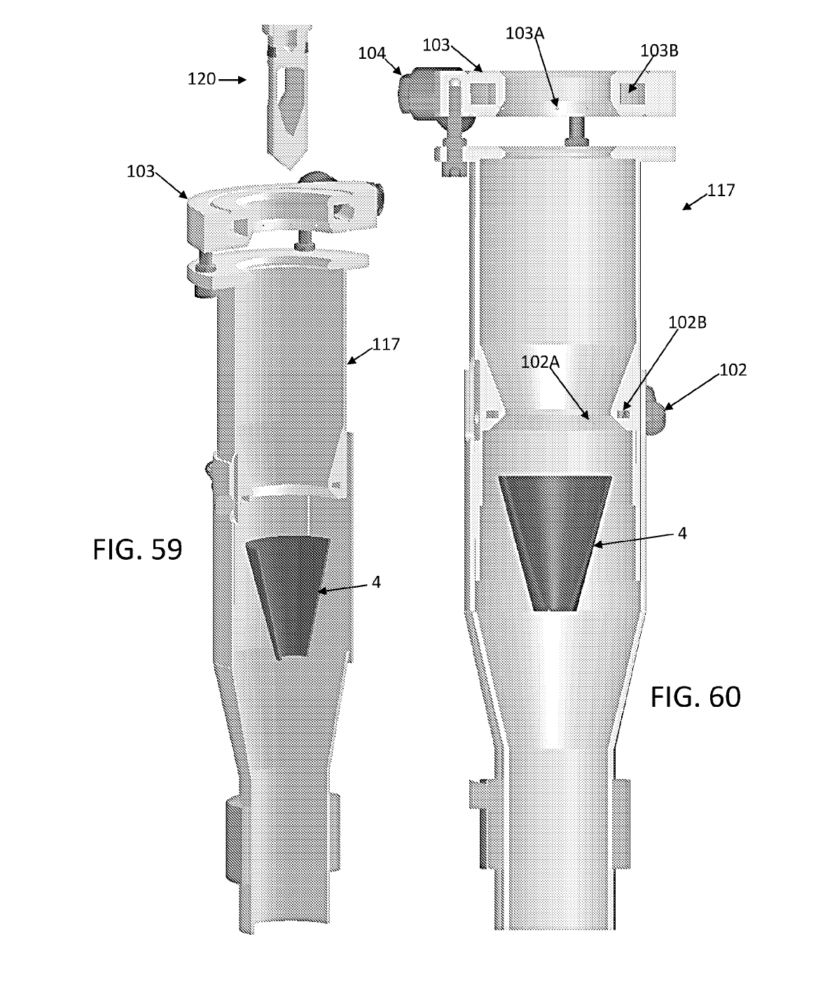

Electrical schematics of a power supply for a gas/liquid cleaning unit 117 according to some non-limiting embodiments, are shown in FIG. 57. As shown, 24 VDC circuits may be secured by a 3A circuit breaker (e.g., according UL10077), without limitation. The circuit may be configured to be in compliance with CSA requirements, for example, the circuit may be configured with a maximum 42 Vdc and a maximum 100 VA for components which are not CUL certified, without limitation.

### Example 4

One exemplary, non-limiting, specification of usage of isopropanol may be as follows. An explosive limit for isopropanol may be 2-12% by volume, without limitation. A preferred maximum of approximately 0.3 litres of gaseous isopropanol may be dispersed in stream of at least approximately 70 litres of air. This preferred concentration of isopropanol may be about a preferred maximum of 0.4% by volume, without limitation. A preferred maximum concentration of isopropanol in exhausting air may be approximately 0.4% by volume, and this may only be in the event the whole amount of liquid isopropanol turns into gas immediately. In some instances, the evaporation of isopropanol may not be instantaneous. Alcohol may be dispersed over approximately 9 seconds into a high diluting vacuum (each de-dusting chamber may have an approximate −40 L/s). Thus, the concentration of isopropanol in exhausted air may be far below a lower explosive limit for equipment, by using approximately 1 ml of isopropanol per second, with an air flow rate of approximately 250 m³/s.

The below tables 1 and 2 suggest exemplary test results, according to certain tested embodiments; wherein a desired specification requirement of a doser 1 may comprise a maximum 0.5% contamination level for most materials, and a maximum 0.1% contamination level for gold exploration activities.

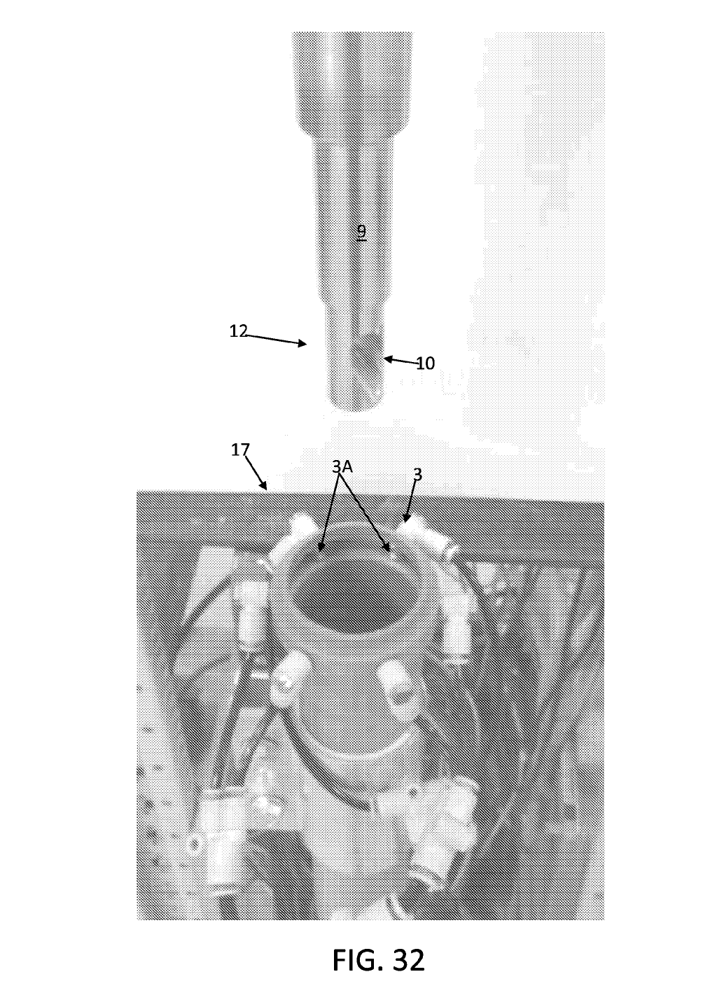

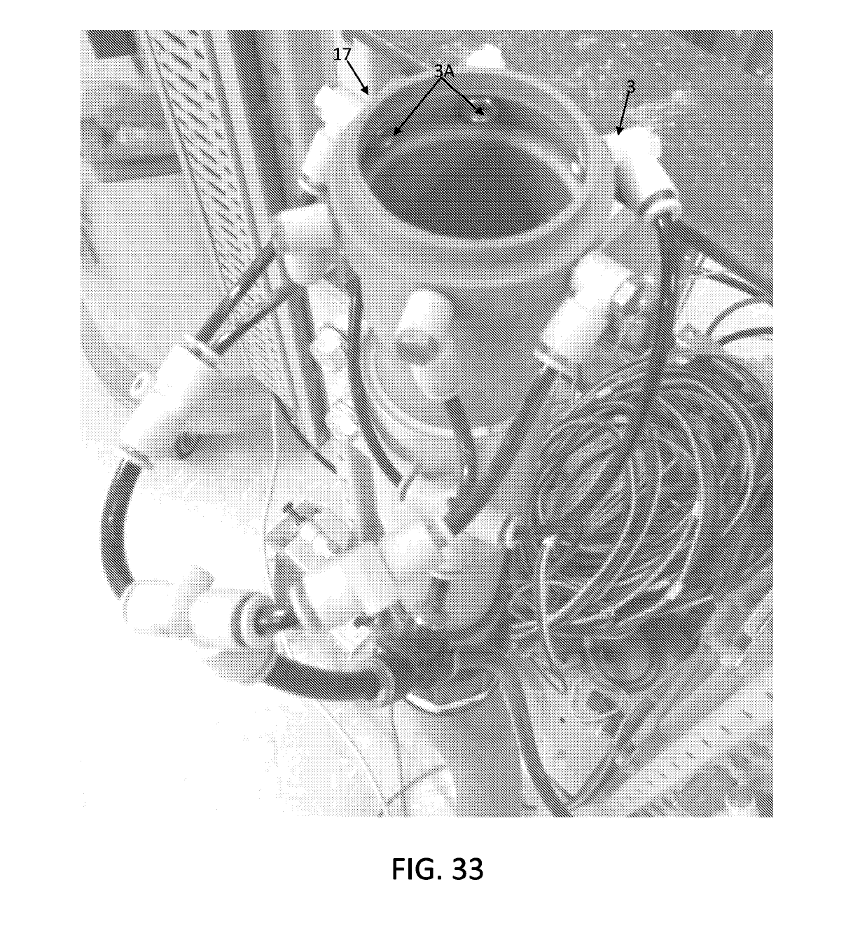

TABLE 1

| | | Fe carryover |
|---|---|---|
| | | in CaCO₃ |
| Cleaning unit type | Equipment part | wt. % |
| Air jets only on top, stand alone device | cleaning of | 0.07 |
| (v1.0 - shown in FIGS. 32 & 34) | dosing head | |
| | only | |
| 3 air jets on top, 3 air jets in the middle, | cleaning of | 0.07 |
| device installed in the Mammoth (v1.1 - | dosing head | |
| shown in FIGS. 21, 41, and 42) | and funnel | |
| Air jets distributed evenly as “micro” | cleaning of | 0.02 |
| jets (v1.2) | dosing head | |
| | and funnel | |
| Air jets combined with liquid spray | cleaning of | <0.01 |
| (e.g., isopropanol) (v2.0 - shown in | dosing head | |
| FIGS. 46-54) | and funnel | |

TABLE 2

| Contaminant | Fe carryover in CaCO₃ wt. % |
|---|---|
| TiO₂ in CaCO₃ | 0.02 |
| CaCO₃ in SiO₂ | 0.02 |
| SiO₂ in CaCO₃ | 0.05 |
| FeₓO_{y} in TiO₂ | 0.05 |
| CaCO₃ in FeₓO_{y} | 0.14 |

Through testing, it has been established that preferred embodiments of a cleaning unit 17 comprising gas jets 3A may be configured to clean doser surfaces with contamination levels at, or about 0.1%. Through testing, it has also been established that preferred embodiments of a cleaning unit 117 which are configured to spray streams 150 of a combination of gas (e.g., air) and a liquid (e.g., alcohol), through jets 103A, may be configured to clean doser surfaces with contamination levels at, or below about 0.01%. Accordingly, gas-only, or combination gas and liquid jet streams 150 may be employed according to various embodiments; wherein for applications requesting contamination levels above 0.1%, gas (e.g., compressed air or nitrogen) gas jets 3A may provide a sufficient solution; whereas for applications requesting contamination levels below 0.1%, gas and/or liquid spray jets 102A, 103A (e.g., compressed air and alcohol spray jets) may be recommended, without limitation.

A contractor or other entity may provide a doser apparatus or operate a doser apparatus in whole, or in part, as shown and described. For instance, the contractor may receive a bid request for a project related to designing or operating a doser apparatus, or the contractor may offer to design any number of doser apparatuses or components thereof, or a process for a client involving one or more of the features shown and described herein. The contractor may then provide, for example, any one or more of the devices or features thereof shown and/or described in the embodiments discussed above. The contractor may provide such devices by selling those devices or by offering to sell those devices. The contractor may provide various embodiments that are sized, shaped, and/or otherwise configured to meet the design criteria of a particular client or customer. The contractor may subcontract the fabrication, delivery, sale, or installation of a component of the devices disclosed, or of other devices used to provide said devices. The contractor may also survey a site and design or designate one or more storage areas for storing the material used to manufacture the devices, or for storing the devices and/or components thereof. The contractor may also maintain, modify, or upgrade the provided devices. The contractor may provide such maintenance or modifications by subcontracting such services or by directly providing those services or components needed for said maintenance or modifications, and in some cases, the contractor may modify a preexisting doser apparatus, subassemblies thereof, components thereof, and/or parts thereof with one or more “retrofit kits” to arrive at a modified doser apparatus or method of operating a doser apparatus comprising one or more method steps, devices, components, or features of the systems and processes discussed herein.

Although the invention has been described in terms of particular embodiments and applications, one of ordinary skill in the art, in light of this teaching, can generate additional embodiments and modifications without departing from the spirit of or exceeding the scope of the claimed. Accordingly, it is to be understood that the drawings and descriptions herein are proffered by way of example to facilitate comprehension of the invention and should not be construed to limit the scope thereof.

### REFERENCE NUMERAL IDENTIFIERS

1 Doser
2 Dosing Funnel Cleaner
2A Dosing Funnel Cleaner Jet(s)
3 Dosing Head Cleaner
3A Dosing Head Cleaner Jet(s)
4 Dosing Funnel
5 Exhaust Connector
6 Linear Stepping Motor
7 Motor
8 Toothed Discs
9 Dosing Tube
10 Dosing Chamber
10A Bottom inclined slope
10B Lower inclined side portions
10C Side portions
10D Upper portion
11 Adjustable Gap
12 Dosing Rod
13 Dosing Chamber Partially or Fully Opened
14 Bearings
16 Distal End of Dosing Funnel (faces sample)
17 Cleaning Unit
18 Race
19 Fastener
20 Spring means (e.g., spring washers)
21 Groove
22 First Wiping Seal
23 Second Wiping Seal
24 Flats
25 Distal Lip
26 Cross-contamination
102 Dosing Funnel Cleaner
102A Dosing Funnel Cleaner Jet(s)
102B Dosing Funnel Cleaner Annular Chamber
103 Dosing Head Cleaner
103A Dosing Head Cleaner Jet(s)
103B Dosing Head Cleaner Annular Chamber
104 Inlet of Mixed Liquid/Gas Dosing Head Cleaner
105 Gas/Liquid Outlet to Dosing Rod and/or Funnel Cleaning Heads (e.g., Air/Alcohol Outlet)
107 One Way Valve
108 Liquid (e.g., Alcohol) Inlet
109 Compressed Gas (e.g., Compressed Air, Compressed Nitrogen) Inlet
117 Cleaning Unit
120 Dosing Rod
130 Pump Box
131 Outlet(s) for Liquid (e.g., Alcohol) to Mixing Chamber
132 Inlet(s) for Liquid (e.g., Alcohol) from Liquid Vessel
133 Safety Sensor Mount
135 Liquid Pump(s)
140 Liquid Vessel(s)
142 Liquid Vessel Outlet(s)
150 Cleaning Stream (e.g., Alcohol+Air Stream)
160 Gap (e.g., for additional air intake)
170 Mixing Chamber(s)

What is claimed is:

1. A dosing apparatus [1] configured to provide a predetermined amount of material from one vessel to another vessel comprising:
a dosing head comprising a dosing tube [9] and a dosing rod [12] movable within said dosing tube [9], the dosing rod [12] comprising a dosing chamber [10], and
a cleaning unit [17, 117] configured to clean the dosing head, which is equipped with one or more jets [2A, 3A] which are configured to expel a gas and/or a liquid.

2. The dosing apparatus [1] according to claim 1, further comprising a first wiping seal [22] between the dosing rod [12] and an inner surface of the dosing tube [9].

3. The dosing apparatus [1] according to claim 2, further comprising an annular groove in the dosing rod [12] which receives said first wiping seal [22].

4. The dosing apparatus [1] according to claim 3, further comprising a second wiping seal between the dosing rod [12] and an inner surface of the dosing tube [9].

5. The dosing apparatus [1] according to claim 1, further comprising a linear stepping motor [6].

6. The dosing apparatus [1] according to claim 1, further comprising a motor [7] operatively communicating with toothed discs [20].

7. The dosing apparatus [1] according to claim 6, further comprising spring means [20] and a fastener [19] operatively connecting at least one of said toothed discs [20] with the dosing rod [12].

8. The dosing apparatus [1] according to claim 7, wherein the spring means [20] comprises one or more stacked spring washers.

9. The dosing apparatus [1] according to claim 1, wherein the dosing chamber [10] comprises a transverse aperture extending through a diameter of said dosing rod [12].

10. The dosing apparatus [1] according to claim 1, wherein the dosing chamber [10] comprises a surface having a bottom inclined slope [10A].

11. The dosing apparatus [1] according to claim 1, wherein the dosing chamber [10] comprises a surface having two lower inclined side portions [10B].

12. The dosing apparatus [1] according to claim 1, wherein the dosing chamber [10] comprises a surface having two side portions [10C].

13. The dosing apparatus [1] according to claim 1, wherein the dosing chamber [10] comprises a surface having an upper portion [10D].

14. (canceled)

15. The dosing apparatus [1] according to claim 1, wherein said gas comprises air.

16. The dosing apparatus [1] according to claim 1, wherein said gas comprises nitrogen.

17. The dosing apparatus [1] according to claim 1, further comprising a vessel [140] in which said liquid is stored.

18. The dosing apparatus [1] according to claim 1, wherein said liquid comprises at least one solvent.

19. The dosing apparatus [1] according to claim 18, wherein said at least one solvent comprises isopropyl alcohol.

20. The dosing apparatus [1] according to claim 1, further comprising a mixing chamber [170] which is configured to mix at least one of the group consisting of: two or more gases; two or more liquids; and at least one gas and at least one liquid.

21. A method of dosing comprising:
providing dosing apparatus [1] configured to provide a predetermined amount of material from one vessel to another vessel, the dosing apparatus [1] comprising a dosing head; the dosing head comprising a dosing tube [9] and a dosing rod [12] movable within said dosing tube [9], the dosing rod [12] comprising a dosing chamber [10];
extending the dosing rod [12] with respect to the dosing tube [9] to expose the dosing chamber [10] from the dosing tube [9] and to increase an adjustable gap [11] between the dosing tube [9] and dosing rod [32];
cleaning the dosing head by placing it into a cleaning unit [17, 117] equipped with one or more jets [2A, 3A] which are configured to expel a gas and/or a liquid,
loading the dosing chamber [10] with a predetermined amount of material from said one vessel; and;
retracting the dosing rod [12] with respect to the dosing tube [9] to close the dosing chamber [10] via the dosing tube [9] and to decrease an adjustable gap [11] between the dosing tube [9] and dosing rod [32].

22. The method of claim 21 further comprising the step of re-extending the dosing rod [12] with respect to the dosing tube [9] to expose the dosing chamber [10] from the dosing tube [9] and to increase an adjustable gap [11] between the dosing tube [9] and dosing rod [32], in order to move some of the predetermined amount of material from the dosing chamber [10] to said another vessel.

23. (canceled)

24. The method of claim 21, wherein said gas comprises air.

25. The method of claim 21, wherein the cleaning unit [17] further comprises an exhaust connector [5].

26. The method of claim 25, wherein the exhaust connector [5] is a tube or pipe which is attached to a vacuum source, or a pressure source which is less than ambient pressure of the environment adjacent the cleaning unit [17].

27. The method of claim 22, wherein the step of re-extending the dosing rod [12] comprises a motor [7] moving relative surfaces of toothed discs [8] biased by spring means [20] to impart a vibration to the dosing head.

28. The method of claim 21, wherein said gas comprises nitrogen.

29. The method of claim 21, wherein said liquid comprises at least one solvent.

30. The method of claim 29, wherein said at least one solvent comprises isopropyl alcohol.
